(19) United States
(12) Patent Application Publication
(10) Pub. No.: US 2004/0125702 A1
(43) Pub. Date: Jul. 1, 2004

(54) Rotational position detection device, hand position detection device and clock using the hand position detection device

(76) Inventors: Hideki Kitajima, Chiba-shi (JP); Masayuki Kawata, Chiba-shi (JP); Shoji Nirasawa, Chiba-shi (JP)

Correspondence Address: ADAMS & WILKS, 31st Floor, 50 Broadway, New York, NY, 10004, US

(21) Appl. No.: 10/689,346

(22) Filed: Oct. 20, 2003

(30) Foreign Application Priority Data
Oct. 21, 2002 (JP) 2002-306264
Nov. 13, 2002 (JP) 2002-329009
Nov. 13, 2002 (JP) 2002-329010

(51) Int. Cl. G04B 19/04; G04B 19/06

(52) U.S. Cl. 368/80

(57) ABSTRACT

A hand rotational position detection device of a watch includes a light emitting part, a reflection face which is formed on a second support body which faces a first support body in an opposed manner with a gap G defined therebetween and on which light from the light emitting part is obliquely incident, a light receiving part which is mounted at a position spaced apart from the light emitting part so as to receive light obliquely reflected on the reflection face, and a disc like rotary body which is arranged in the gap defined between the first and the second support bodies and includes an opening which opens an incident optical path Pi leading from the light emitting part to the reflection face and a reflection optical path leading from the reflection face to the light receiving part when the disc-like rotary body assumes a first rotational position with respect to the first support body, wherein when the disc-like rotary body is at the first rotational position, an imaginary line which connects the incident and the reflection optical path parts in which the incident and reflection optical paths pass through in the opening extended in the direction which intersects the radial direction of the disc-like rotary body.

### BACKGROUND OF THE INVENTION

1. Field of the Invention

The present invention relates to a rotational position detection device of a disc-like rotary body, a hand position detection device using the rotational position detection device, and a watch using the hand position detection device.

2. Description of the Prior Art

With respect to an electronic wave correction clock, there has been known a technique in which a hand (a time indicating hand) is made to return to an initial position and, then, in response to time information contained in the standard electronic wave, the hand is further forcibly moved to a position corresponding to the time information.

In this type of electronic wave correction clock, time at which the hand position of the clock is at the initial position (internal time) is detected. Next, time information contained in the standard electronic wave is detected, a hand is forcibly driven or stopped in response to difference between the internal time and time obtained from the time information, and the hand is made to correspond to a time obtained by the time.

The hand position detection device is classified into a reflective-type hand position detection device which uses a reflection mirror and a transmissive-type hand position detection device which does not use the reflection mirror. The conventional reflective-type hand position detection device includes a sensor which is integrally provided with a light emitting part and a light receiving part and is mounted on a base support, a reflection mirror which is mounted on a second base support which is arranged in a spaced apart manner from the first base support in a state that the reflection mirror faces the sensor such that the an incident light from the light emitting part of the sensor is reflected on the reflection mirror as a reflection light to be directed to the light receiving part, and a disc-like gear which is arranged in the gap defined between the first and the second base supports and is rotated in synchronism with the rotation of a hand, wherein the disc-like gear includes a hole which opens an optical path such that when the disc-like gear assumes a given rotational position with respect to the first base support, light emitted from the light emitting part impinges on the reflection mirror and the reflection light from the reflection mirror is received by the light receiving part (see Japanese Patent 2941576 (Patent Described Publication) and Japanese Unexamined Patent Publication 2000-35489, for example).

However, with respect to these prior arts, since the sensor is arranged in parallel in the radial direction of the gear, even when the light emitting part and the light receiving part which constitute the sensor are arranged as close as possible to each other to make the sensor compact, it is difficult to decrease a radius of the gear. Further, with respect to a plurality of disc-like gears which have rotational center axes thereof positioned in parallel to each other in a spaced-apart manner and portions of disc-like portions thereof to face each other in a spaced-apart manner, when a pair of sensors and the reflection mirror try to simultaneously detect that the plurality of gears reach the initial position, the distance between the rotational center axes of the gears is liable to be increased. On the other hand, when the distance between the light emitting part and the light receiving part of the sensor is small, the sensor is liable to easily make an erroneous operation such that a portion of light which is emitted in a spreading manner from the light emitting part directly enters the light receiving part or a portion of light emitted from the light emitting part impinges and is reflected on a foreign object in the vicinity of the sensor and enters the light receiving part as a stray light. Further, depending on the manner of arrangement, the thickness of the rotational position detection device is easily increased. When it is necessary to miniaturize the rotational position detection device such as the detection of hand position of a watch, this drawback is liable to become outstanding.

The present invention is made in view of the above-mentioned aspects and it is an object of the present invention to provide a rotational position detection device which can achieve the miniaturization of the device and the minimization of thickness and can reduce the possibility of making erroneous operations, a hand position detection device which uses the rotational position detection device, and a watch which uses the hand position detection device.

### SUMMARY OF THE INVENTION

To achieve the above-mentioned object, a rotational position detection device according to the present invention includes a rotational position detection device comprising, a first light emitting part which is mounted on a first support body, a first reflection face which is formed on a second support body which is arranged to face the first support body with a gap therebetween such that light from the first light emitting part is obliquely incident on the first reflection face, a first light receiving part mounted on the first support body at a position away from the first light emitting part to receive light obliquely reflected on the first reflection face, and a first disc-like rotary body which is arranged in the gap between the first and the second support bodies, the first disc-like rotary body having a first opening means which opens a first incident optical path leading from the first light emitting part to the first reflection face and a first reflection optical path leading from the first reflection face to the first light receiving part when the first disc-like rotary body assumes a first rotational position with respect to the first support body, wherein when the first disc-like rotary body assumes the first rotational position, a first imaginary line which connects a first incident optical path part in which the first incident optical path passes through and a first reflection optical path part in which the first reflection optical path passes through in the first opening means extends in the direction which intersects the radial direction of the first disc-like rotary body.

In the rotational position detection device according to the present invention, due to the constitution “when the first disc-like rotary body assumes the first rotational position where the first opening means opens the first incident and reflection optical paths, a first imaginary line which connects a first incident optical path part in which the first incident optical path passes through and a first reflection optical path part in which the first reflection optical path passes through in the first opening means extends in the direction which intersects the radial direction of the first disc-like rotary body”, even when the distance between the light emitting part and the light receiving part is large, the increase of the diameter of the disc-like rotary body can be easily obviated whereby the miniaturization can be facilitated. In other words, it is possible to increase the distance between the light emitting part and the light receiving part while obviating the increase of a planar shape of the device by obviating the increase of the radius of the disc-like rotary body whereby the possibility of occurrence of an erroneous operation which may be caused when the light receiving part receives a stray light from the light emitting part can be suppressed to low level.

Here, in the rotational position detection device according to the present invention, a radial directional line which connects an intermediate point of the first imaginary line and the center of the first disc-like rotary body is preferably set to an angle of at least 30 degrees or more and 45 degrees or more with respect to the first imaginary line, and is typically set substantially orthogonal to the first imaginary line.

Further, the rotational position detection device according to the present invention includes the constitution “in addition to a first reflection face which is formed on a second support body which is arranged to face the first support body with a gap therebetween such that light from the first light emitting part is obliquely incident on the first reflection face, a first light receiving part mounted on the first support body at a position away from the first light emitting part to receive light obliquely reflected on the first reflection face is formed” so as to allow the incidence of the oblique incident light to the reflection face and the reception of the oblique reflected light whereby even when the distance between the light emitting part and the light receiving part is increased, the distance between the first support body on which the light emitting part and the light receiving part are mounted and the second support body on which the reflection face is formed can be suppressed to a small value thus realizing the reduction of thickness of the device.

In the rotational position detection device according to the present invention, the first opening means may be comprised a first elongated opening which continuously extends between the first incident optical path part and the first reflection optical path part or may be comprised a first incident optical path forming small opening portion which allows passing of incident light from the first light emitting part to the first reflection face and a first reflection optical path forming small opening portion which is arranged spaced apart from the first incident optical path forming small opening portion and allows passing of reflection light from the first reflection face to the first light receiving part.

When the first opening means is comprised the first incident optical path forming small opening portion and the first reflection optical path forming small opening portion which are spaced apart from each other, a separation wall portion formed between the incident optical path forming small opening portion and the reflection optical path forming small opening portion prevents the invasion of a stray light and hence, the change of light quantity which is obtained at the light receiving part along with the rotation of the first disc-like rotary body becomes acute whereby the angular (detection) resolution with respect to the rotation of the disc-like rotary body can be enhanced.

In the rotational position detection device according to the present invention, “opening means” is typically is formed of a hole. Although “elongated opening” and “small opening portion” are typically formed of an elongated hole and a small hole respectively, they may be formed of a wall portion made of a light transmitting material in place of holes. Further, peripheral wall portions of the “elongated opening” and “small opening portion” which constitute the opening means typically extend in parallel to the thickness direction of the disc-like rotary body. However, in the first rotational position, when the peripheral wall portions are related to opening/closing of the incident optical path and the reflection optical path, the peripheral wall portion may extend substantially in parallel to the extending direction of the relevant optical path (incident optical path and reflection optical path) and obliquely with respect to the thickness direction of the disc-like rotary body.

Although a set of light emitting and light receiving parts and the reflection face may be formed for one disc-like rotary body, typically, a set of light emitting and light receiving parts and the reflection face are arranged for a plurality of disc-like rotary body.

For example, when at least two disc-like rotary bodies are made relevant to the set of light emitting and light receiving parts and the reflection face, the rotational position detection device of the present invention typically further includes a second disc-like rotary body which is arranged parallel to the first disc-like rotary body in the gap between the first and the second support bodies, the second disc-like rotary body including a second opening means which opens a first incident optical path leading from the first light emitting part to the first reflection face and the first reflection optical path leading from the first reflection face to the first light receiving part when the second disc-like rotary body assumes a second rotational position with respect to the first support body, wherein a second imaginary line which connects a second incident optical path part in which the first incident optical path passes through and a second reflection optical path part in which the first reflection optical path passes through out of the second opening means extends in the direction which intersects the radial direction of the second disc-like rotary body and is parallel to the first imaginary line when the first and the second disc-like rotary bodies respectively assume the first and the second rotational positions.

Here, the manner of arranging and constituting the second opening means can be selected as desired in the same manner as the first opening means. That is, it is preferable that a radial directional line which connects an intermediate point of the second imaginary line and the center of the second disc-like rotary body is set substantially orthogonal to the second imaginary line. Further, the second opening means may be comprised a second elongated opening which continuously extends between the second incident optical path part and the second reflection optical path part or may be comprised a second incident optical path forming small opening portion which allows passing of incident light from the first light emitting part to the first reflection face and a second reflection optical path forming small opening portion which is arranged spaced apart from the second incident optical path forming small opening portion and allows passing of reflection light from the first reflection face to the first light receiving part.

When the fact that at least two disc-like rotary bodies assume given rotational positions is detected by a set of the light emitting part, the light receiving part and the reflection face, the second disc-like rotary body may be concentrically arranged with the first disc-like rotary body or a rotational center axis of the second disc-like rotary body may extend in parallel to a rotational center axis of the first disc-like rotary body with a distance defined therebetween. In the former case, another second disc-like rotary body similar to the second disc-like rotary body may be further stacked in the extension direction of the axis.

In the latter case, it is preferable that the first and the second imaginary lines may make an angle of 30 degrees or more and 45 degrees or more and may typically extend in the orthogonal direction with respect to the direction which connects the rotational center axes of the first and the second disc-like rotary bodies. Due to such a constitution, the light emitting part and the light receiving part are positioned away from the rotational center axes of the first and the second disc-like rotary bodies and hence, the distance between the rotational center axes of the first and the second disc-like rotary bodies can be minimized where by the device can be miniaturized. Further, in the latter case, for example, when the first and the second disc-like rotary bodies are coupled to each other such that the rotation of the second disc-like rotary body is transmitted to the first disc-like rotary body at a reduced speed, by simultaneously detecting that the second disc-like rotary body is at a given position in addition to the detection that the first disc-like rotary body is at the given position, it is possible to detect and confirm that the first disc-like rotary body is at the given position with a high angular resolution.

Here, the rotational position detection device of the present invention may be configured such that, when a plurality of disc-like rotary bodies, for example, the first and the second disc-like rotary bodies are arranged concentrically, the rotational position of the third disc-like rotary body which is rotated about a rotational center axis which is spaced apart from the rotational center axes of the first and the second disc-like rotary bodies and extends parallel to the rotational center axes of the first and the second disc-like rotary bodies is also collectively detected by a set of the light emitting part and the light receiving part and the reflection face. In this case, the rotational position detection device further includes a third disc-like rotary body which is rotated about a rotational center axis which extends parallel to the rotational center axes of the first and the second disc-like rotary bodies in a spaced apart manner from the rotational center axes of the first and the second disc-like rotary bodies, the third disc-like rotary body including a third opening means which opens a first incident optical path leading from the first light emitting part to the first reflection face and the first reflection optical path leading from the first reflection face to the first light receiving part when the third disc-like rotary body assumes a third rotational position with respect to the first support body, wherein a third imaginary line which connects a third incident optical path part in which the first incident optical path passes through and a third reflection optical path part in which the first reflection optical path passes through out of the third opening means extends in the direction which intersects the radial direction of the third disc-like rotary body and is parallel to the first and the second imaginary lines when the first, the second and the third disc-like rotary bodies respectively assume the first, the second and the third rotational positions.

Further, in the rotational position detection device of the present invention, a plural sets of detection systems each consisting of the light emitting part, the light receiving part and the reflection face may be used for detecting the rotational positions of the plurality of rotary bodies.

In this case, the rotational position detection device according to the present invention, in addition to at least the first disc-like rotary body, further includes a second light emitting part which is mounted on the first support body, a second reflection face which is formed on a third support body which faces the first support body with a gap therebetween such that light from the second light emitting part is obliquely incident on the second reflection face, a second light receiving part which is mounted at a position spaced apart from the second light emitting part in the first support body to receive light reflected obliquely on the second reflection face, and a fourth disc-like rotary body which is arranged in the gap between the first and third support bodies, the fourth disc-like rotary body having a fourth opening means which opens the second incident optical path leading from the second light emitting part to the second reflection face and a second reflection optical path leading from the second reflection face to the second light receiving part when the fourth disc-like rotary body assumes a fourth rotational position with respect to the first support body, wherein a fourth imaginary line which connects a fourth incident light optical path part in which the second incident optical path passes through and a fourth reflection optical path part in which the second reflection optical path passes through out of the fourth opening means extends in the direction which intersects the radial direction of the fourth disc-like rotary body when the fourth disc-like rotary body assumes the fourth rotational position. Here the third support body may be movable either integrally with the second support body or relative to the second support body. For example, the rotational position detection device further includes another disc-like rotary body similar to the fourth disc-like rotary body.

Also in this case, a radial directional line which connects an intermediate point of the fourth imaginary line and the center of the fourth disc-like rotary body is set to an angle of preferably at least 30 degrees or more and 45 degrees or more with respect to the fourth imaginary line, and is typically set substantially orthogonal to the fourth imaginary line. Further, the fourth opening means may be comprised a fourth elongated opening which continuously extends between the fourth incident optical path part and the fourth reflection optical path part or the fourth opening means may be comprised a fourth incident optical path forming small opening portion which allows passing of incident light from the second light emitting part to the second reflection face and a fourth reflection optical path forming small opening portion which is arranged spaced apart from the fourth incident optical path forming small opening portion and allows passing of reflection light from the second reflection face to the second light receiving part.

In the above-mentioned constitutions, the second support body may be placed in a stationary state with respect to the first support body or the second support body may be comprised a fifth disc-like rotary body which is concentric with the first disc-like rotary body.

In the latter case, it is preferable that a main surface of the fifth disc-like rotary body at a first-reflection-face side includes a recessed portion in a small region having the reflection face and the reflection face is formed in a bottom face of the recessed portion. In this case, even when reflection is generated more or less at portions of the main surface other than the reflection faces, an optical path of the reflection light which is obliquely incident on the main surface is shifted from the reflection optical path of the reflection face and hence, the possibility that the light receiving part erroneously receives light can be reduced.

In the rotational position detection device according to the present invention, the disc-like rotary body is typically formed of a disc-like gear part.

In a hand position detection device according to the present invention, a first disc-like rotary body (for example, a fourth wheel (a second hand wheel)) and a disc-like rotary body (for example, a second wheel (a minute hand wheel) or cylindrical wheel (an hour hand wheel)) which is concentric with the first disc-like rotary body are provided with time indication hands (for example, a second hand, a minute hand or an hour hand) at one ends of rotary axis of the rotary bodies. In this case, a given rotational position of each disc-like rotary body (disc-like gear) such as the first rotational position is typically an initial position (for example, a position of right 12 o'clock) which the corresponding time indication hand indicates. However, the given rotational position may be set to other position. Further, a disc-like rotary body (for example, a fifth wheel, a third wheel or the like) which is positioned in a spaced apart manner from the rotational center axis of the first disc-like rotary body is coupled to the first disc-like rotary body or the like with respect to rotation and hence, the simultaneous detection that these disc-like rotary bodies reach given rotational positions is useful for accurately positioning the rotational position of the disc-like rotary body (for example, the fourth wheel, the second wheel or the like) which is coupled with the reduced speed rotation.

The rotational position detection device according to the present invention and the hand position detection device according to the present invention are suitable for realizing the miniaturization and the reduction of thickness and hence, they may be incorporated into a watch as a part thereof. The watch may be a watch having an electronic wave correction function or a watch having no such a function. Further, when desired, the rotational position detection device according to the present invention and the hand position detection device according to the present invention may be incorporated into an equipment larger than a clock.

In the above-mentioned constitutions, the first support body is typically formed of a printed circuit board and a circuit block connected to the printed circuit board or the like, while the light emitting part is typically formed of a portion including a light emitting element such as an LED (Light Emitting Diode). The light emitting part may have an optical axis which is directed from the first support body in the direction orthogonal to the second support body or the like which faces the first support body. However, if desired, the light emitting part may have an axis thereof directed obliquely to the first board such that an optical axis of the light emitting part per se (a center axis of the light being emitted) is aligned with the incident optical path which is obliquely incident on the reflection face. It is needless to say that instead of directing the light emitting element of the light emitting part obliquely, small optical systems which regulate the shape of the beam and the direction of the beam may be integrally formed over the whole surface of the light emitting element of the light emitting part.

The light receiving part is typically formed of a portion which includes a light receiving element such as a photo transistor. The light receiving part may have an optical axis which is directed in the direction orthogonal to the second support body or the like on which the reflection face is formed. However, if necessary, the optical axis maybe directed obliquely with respect to the first support body such that an optical axis of the light receiving part per so (axis passing through the center of the light receiving face and being directed in the direction orthogonal to the light receiving face) is aligned with the reflection optical path which is directed obliquely from the reflection face it is needless to say, that instead of directing the light receiving element of the light receiving part obliquely, small optical systems which regulate the shape of the beam and the direction of the beam may be integrally formed over the whole surface of the light receiving element of the light receiving part.

When the detection system is incorporated into a miniaturized equipment such as a watch, the light emitting part and the light receiving part may include light emitting ends, or light receiving ends of optical fibers in place of incorporating the light emitting element and the light receiving element into the watch per se.

In the above-mentioned constitutions, to suppress the possibility that the light receiving part directly receives a portion of light emitted from the light emitting part or receives a stray light from the light emitted from the light emitting part to a minimum level, it is preferable that a light shielding wall which can prohibit the direct incidence of the portion of the light emitted from the light emitting part or can suppress the incidence of the stray light of the light emitted from the light emitting part to the light receiving part to a minimum level is formed such that the light shielding wall projects from a mounting region on which at least one of the light emitting part and the light receiving part is mounted between the light emitting part and the light receiving part or to apply the surface treatment so as to prevent the reflection of the stray light.

Further, here, the light shielding wall may be formed of a surrounding wall portion which is projected on a substantially planar board surface. However, if desired, recessed portions may be formed in portions of the surface of the board and bottom portions of the recessed portions may be used as regions on which the light emitting element and the light receiving element are mounted. In this case, peripheral walls of the recessed portions function as the light shielding walls. Further, at least one of the light emitting part and the light receiving part may be formed such that one of them is inserted into the inside of an opening portion which is formed in a penetrating manner in the board which makes one main surface thereof face the reflection face in an opposed manner whereby the element is surrounded by the peripheral wall of the opening. In this case, by merely inserting the element to be inserted into the opening portion into the opening, the peripheral wall functions as the light shielding wall and, at the same time, since the element is mounted in place, it is also possible to obtain an additional advantageous effect that the positioning accuracy of the element can be enhanced.

Further, the light shielding wall is typically formed on the whole periphery of the region on which the light emitting elements and the light receiving element are formed. However, depending on cases, a portion of the light shielding wall may be opened such that the planar shape assumes a square C-shape or a rounded C-shape. Further, although the region where the light emitting element and the light receiving element are mounted typically forms a face which is parallel to the extending direction of the board, in some cases, the region may be inclined with respect to the extension direction of the board.

Further, to suppress the possibility that light emitted from the light emitting part is not reflected on the reflection face and is erroneously received by the light receiving part to a minimum level, means which restricts the emitting direction of the light emitted from the light emitting part may be formed on a light irradiating portion of the light emitting part, or means which regulates the incidence direction of the light which is incident on the light receiving part may be formed on a light receiving face portion of the light receiving part.

The light emitting part and the light receiving part are arranged at positions which form a V shape using the reflection face as the center and hence, provided that the reflection face can reflect the incident light which is incident on the reflection face obliquely in the oblique direction, the reflection face may be formed of a surface of the reflection mirror which is mounted on the second support body or the like, may be formed of reflection layers which are adhered to or stacked to the second support body, or may be formed of a mirror-finished surface portion obtained by polishing a portion of the surface of the second support body.

### BRIEF DESCRIPTION OF THE SEVERAL VIEWS OF THE DRAWINGS

A preferred form of the present invention is illustrated in the accompanying drawings in which:

FIG. 1 are views showing a watch having a hand position detection device of a preferred first embodiment according to the present invention, wherein A is across-sectional explanatory view taken along a line IA-IA in C, B is a cross-sectional explanatory view taken along a line IB-IB in A and C is a cross-sectional explanatory view taken along a line IC-IC in A;

FIG. 2 are views showing a watch having a hand position detection device of a preferred second embodiment according to the present invention, wherein A is across-sectional explanatory view taken along a line IIA-IIA in C, B is a cross-sectional explanatory view taken along a line IIB-IIB in A and C is a cross-sectional explanatory view taken along a line IIC-IIC in A;

FIG. 3 are views showing a watch having a hand position detection device of a preferred third embodiment according to the present invention, wherein A is a cross-sectional explanatory view taken along a line IIIA-IIIA in B (however, a wheel train acceptor not shown in the drawing) and B is a cross-sectional explanatory view taken along a line IIIB-IIIB in A;

FIG. 4 are views showing a watch having a hand position detection device of a preferred third embodiment according to the present invention, wherein A is a cross-sectional explanatory view taken along a line IVA-IVA in FIG. 3A (however, a wheel train acceptor not shown in the drawing) and B is a cross-sectional explanatory view taken along a line IVB-IVB in FIG. 3A (however, a wheel train acceptor not shown in the drawing);

FIG. 5 are views showing a watch having a hand position detection device of a preferred fourth embodiment according to the present invention, wherein A is a cross-sectional explanatory view taken along a line VA-VA in B (however, a wheel train acceptor not shown in the drawing), B is a cross-sectional explanatory view taken along a line VB-VB in A and C is a cross-sectional explanatory view similar to B when an hour hand wheel is at a position offset from an initial position;

FIG. 6 are views showing a watch having a hand position detection device of a preferred fifth embodiment according to the present invention, wherein A is a cross-sectional explanatory view similar to FIG. 5B, B is a cross-sectional explanatory view similar to A when an hour hand wheel is at a position offset from an initial position in the same manner as FIG. 5C, C is a cross-sectional explanatory view similar to FIG. 5B when an hour hand wheel which is different from the hour hand wheel shown in A is used, and D is a cross-sectional explanatory view similar to A when an hour hand wheel is at a position offset from an initial position in the same manner as FIG. 5C when an hour hand wheel different from the hour hand wheel shown in A is used;

FIG. 7 are views showing a watch having a hand position detection device of a preferred sixth embodiment according to the present invention, wherein A is a cross-sectional explanatory view similar to FIGS. 6A and B is a cross-sectional explanatory view similar to FIG. 6B;

FIG. 8 are views showing a watch having a hand position detection device of a preferred seventh embodiment according to the present invention, wherein A is a cross-sectional explanatory view taken along a line VIIIA-VIIIA in B (however, a wheel train acceptor not shown in the drawing) and B is a cross-sectional explanatory view taken along a line VIIIB-VIIIB in A;

FIG. 9 are views showing a watch having a rotational detection device of a preferred embodiment adopting a light shielding structure according to the present invention, wherein A is a cross-sectional view taken along a line XA-XA in B and B is a cross-sectional explanatory view taken along a line XB-XB in FIG. 10;

FIG. 10 is a cross-sectional explanatory view taken along a line XI-XI in FIGS. 9A, B (however, a printed circuit board being omitted from the drawing);

FIG. 11 are views showing the detail of a portion of the watch in FIG. 10, wherein A is a cross-sectional explanatory view taken along a line XIIA-XIIA in FIGS. 10 and B is a cross-sectional explanatory view taken along a line XIIB-XIIB in FIG. 10;z

FIG. 12 are views showing a watch having a rotational detection device of other preferred embodiment having a light shielding structure according to the present invention, wherein A is a cross-sectional view taken along a line XIIIA-XIIIA in B and B is a cross-sectional explanatory view taken along a line XIIIB-XIIIB in FIG. 10;

FIG. 13 is a cross-sectional explanatory view taken along a line XIV-XIV in FIGS. 12 A, B (however, a printed circuit board being omitted from the drawing); and

FIG. 14 are views showing the detail of a portion of the watch shown in FIG. 13, wherein A is a cross-sectional explanatory view taken along a line XVA-XVA in FIG. 13 and B is a cross-sectional explanatory view taken along a line XVB-XCB in FIG. 10.

### DETAILED DESCRIPTION OF THE PREFERRED EMBODIMENTS

Next, some preferred embodiments of the present invention are explained in conjunction with preferred embodiments shown in attached drawings.

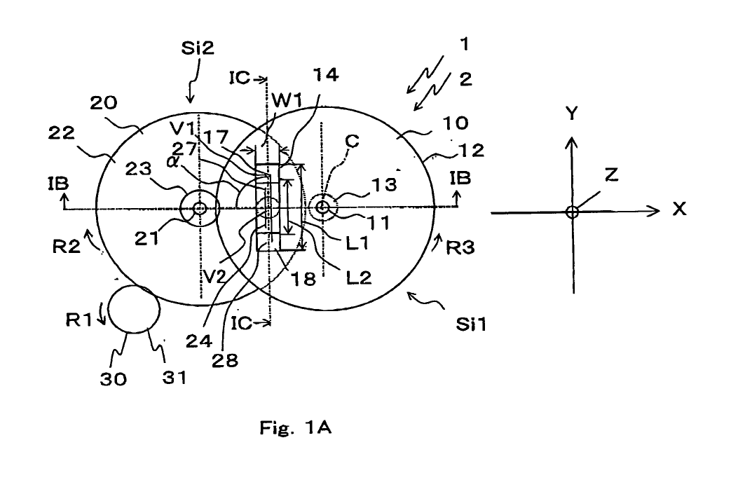

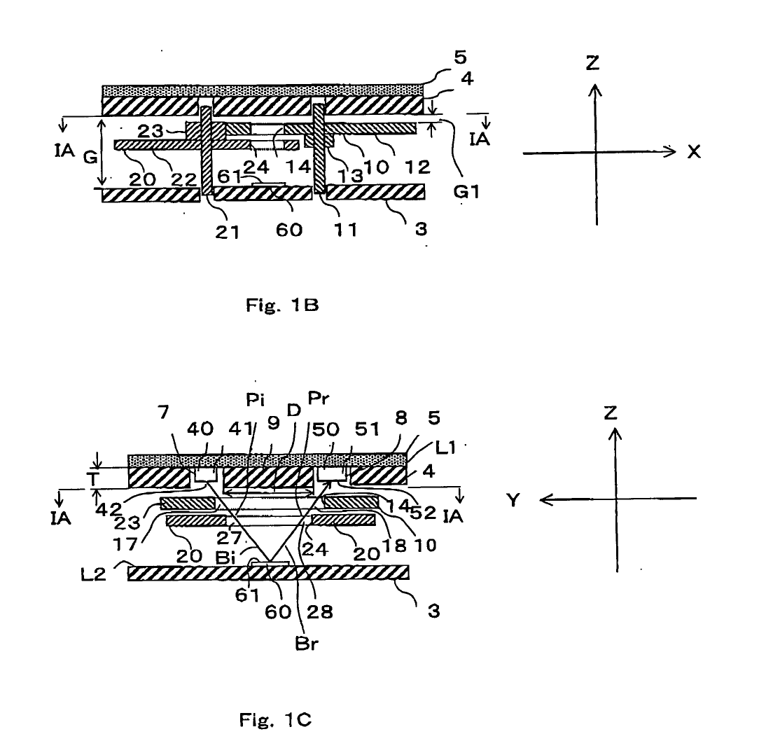

A watch 2 provided with a hand position detection device 1 as a rotational position detection device of the first preferred embodiment according to the present invention shown in FIG. 1 includes a base plate 3 which is placed in a stationary manner with respect to a case (not shown in the drawing) of the watch 2, a gear train acceptor 4 which is placed in a stationary manner with respect to the base plate 3 by way of a gap G1 and a printed circuit board 5, wherein a fourth wheel 10 and a fifth wheel 20 are arranged between the base plate 3 and the gear train acceptor 4. The fourth wheel 10 which constitutes a first disc-like rotary body includes a rotational center axis 11 which extends along a rotational center axis C of the watch 2, a disc-like fourth gear portion 12 and a small gear or a pinion portion 13, wherein a second hand is mounted on a distal end (below FIG. 1B although not shown in the drawing) of the rotational center axis 11. The fifth wheel 20 which constitutes a second or a third disc-like rotary body also includes a rotational center axis 21, a disc-like fifth gear portion 22 and a small gear or a pinion portion 23, wherein the pinion portion 23 is meshed with the fourth gear portion 12 and the fifth gear portion 22 is meshed with a rotor axis 31 of a motor 30. The base plate 3 extends substantially in parallel to the printed circuit board 5 and the gear train acceptor 4. The rotational center axis 21 of the fifth wheel 20 is arranged parallel to the rotational center axis 11 of the fourth wheel 10.

An elongated hole 14 having a width of W1 and a length of L1 is formed in the fourth gear portion 12, while an elongated hole 24 having a width of WI and a length of L2 is formed in the fifth gear portion 22. The elongated hole 14 which constitutes a first elongated opening as the first opening means is formed in the fourth gear 12 at a position and in the direction where a perpendicular bisector of long sides of a rectangular shape thereof is aligned with a radial direction of the fourth gear 12. In the same manner, the elongated hole 24 which constitutes a second elongated opening as the second opening means is formed in the fifth gear 22 at a position and in the direction where a perpendicular bisector of long sides of a rectangular shape thereof is aligned with a radial direction of the fifth gear 22. Here, as can be understood from FIG. 1 A, the elongated holes 14, 24 of the fourth and the fifth gears 10, 20 are formed such that when the fourth gear portion 12 and the fifth gear portion 22 assume given rotational positions (hereinafter, these positions being referred to as initial positions S1i, S2i respectively, and these positions being assumed as positions where second hands are positioned at 00 second which indicates the position of just 12 o'clock), the elongated hole 14 of the fourth gear portion 12 and the elongated hole 24 of the fifth gear portion 22 are at positions and directions where these holes 14, 24 are just overlapped to each other. In this overlapped state, the elongated holes 14, 24 have side faces thereof in the widthwise direction made substantially coplanar and end faces thereof in the lengthwise direction substantially made spaced apart from neighboring end walls by an equal distance

In this hand position detection device 1, the elongated holes 14, 24 extend in the direction (hereinafter referred to as the Y direction) which is orthogonal to the direction which connects the rotational center axis 11, 21 (hereinafter referred to as the X direction) and hence, it is possible to increase the lengths of the elongated holes 14, 24 compared to the distance between the axis 11, 21. In other words, even when the lengths of the elongated holes 14, 24 are made relatively longer, it is unnecessary to increase the distance between the axis 11, 21 whereby it is possible to miniaturize the watch 2 by suppressing the, increase of the size of the watch 2.

Through holes or openings 7, 8 are formed in the gear train acceptor 4, while on portions 41, 51 of a surface U1 of the printed circuit board 5 which face the openings 7, 8, a light emitting element 40 such as an LED which constitutes a light emitting part and a light receiving element 50 such as a photo transistor which constitutes a light receiving part are mounted. The light emitting part may include as an optical system, a drive circuit and the like besides the light emitting element, while the light receiving part may include other optical system including an optical filter and the like, an amplifier circuit and the like besides the light receiving element. In an example shown in FIG. 1C, in the light emitting element 40 and the light receiving element 50, lower end faces thereof-which constitute a light emitting face 42 and a light receiving face 52 respectively extend in the direction orthogonal to the extending direction (hereinafter referred to as the Z direction) of an axis C. Typically, as can be understood from FIG. 1C, a thickness T of the gear train acceptor 4 is set larger than a height of the light emitting element 40 and the light receiving element 50 so that the light emitting face 42 of the light emitting element 40 and the light receiving face 52 of the light receiving element 50 are completely housed in the inside of the openings 7, 8 of the gear train acceptor 4. Accordingly, the light emitting element 40 and the light receiving element 50 are separated from each other by a wall portion 9 of the gear train acceptor 4 between the openings 7, 8 so that there is a small possibility that light emitted from the light emitting face 42 of the light emitting element 40 is incident on the light receiving face 52 of the light receiving element 50 as a stray light. Further, the fourth gear portion 12 sufficiently approaches the gear train acceptor 4 compared to the length D of the partition wall portion 9 and faces the train gear acceptor 4 by way of a narrow gap G1. Accordingly, light emitted from the light emitting element 40 repeats reflection of the light between the partition wall portion 9 of the train gear acceptor 4 and a face of the fourth gear portion 12 which faces the partition wall portion 9 and hence, the light is sufficiently weakened when the light reaches the light receiving element 50.

On the other hand, on a surface U2 of the base plate 3 at a side which faces the printed circuit board 5 and the gear train acceptor 4, a reflection mirror 60 is mounted. To be more specific, the reflection mirror 60 is positioned on the surface U2 of the base plate 3 along a line which connects the rotary axis 11, 21 of the fourth and fifth gears 10, 20 and has a thin disc-like shape, for example. However, the reflection mirror 60 may have any structure, may be made of any material and may have any shape provided that when light Bi from the light emitting element 40 impinges on a surface 61 thereof, the incident light Bi is reflected as a reflection light Br and can be transmitted to the light receiving element 50. That is, provided that the reflection mirror 60 includes the effective reflection face 61, the reflection mirror may adopt any constitution. For example, the reflection mirror 60 may be formed of a disc laminated to the base plate 3, a stacked layer which is formed on the base plate 3 by adhesion, or a surface portion of the base plate 3 which is polished like a mirror surface so as to exhibit the sufficient reflectance. Here, the reflection mirror 60 may be formed in a wider range in place of forming the reflection mirror 60 only in a small region.

In the hand position detection device 1 shown in FIG. 1, the light emitting face 42 of the light emitting element 40 and the light receiving face 52 of the light receiving element 50 are directed in the Z direction. However, to direct the light emitting face 42 and the light receiving face 52 to the reflection face 61, at least one of the light emitting element 40 and the light receiving element 50 may be obliquely mounted with respect to the printed circuit board 5 such that the light emitting face 42 and the light receiving face 52 are directed orthogonal to the incident optical path Pi of the incident light Bi and a reflection optical path Pr of the reflecting light Br or an optical system which can change the direction of beams may be provided to the light emitting face or the light receiving face.

In the hand position detection device 1 having such a constitution, the fifth wheel 20 is rotated in the R2 direction in response to the rotation of the rotor axis 31 of the motor 30 in the R1 direction, while the fourth wheel 10 is rotated in the R3 direction in response to the rotation of the fifth wheel 20 in the R2 direction.

As in the case of the electronic wave correction, when a command which makes the fourth wheel 10 and the fifth wheel 20 set to the respective initial values S1i, S2i is issued, a hand position control part (not shown in the drawing) starts high-speed rotation driving of the motor 30 and, at the same time, drives the light emitting element 40 such as an LED so as to start the emission of light.

When both of the fifth wheel 20 and the fourth wheel 10 are arranged remotely away from the initial positions Si2, Si1, the elongated holes 24, 14 reach neither one of the optical path Pi of the incident beam bi leading from the light emitting element 40 to the reflection mirror 60 and the optical path Pr of the reflecting beam Br leading from the reflection mirror 60 to the light receiving element 50 and hence, the optical path Pi is blocked by disc-like portions of the gear portions 22, 12 of the fifth wheel 20 and the fourth wheel 10 whereby the beam Bi emitted from the light emitting element 40 does not reach the reflection mirror 60. Further, it is needless to say that the beam Bi does not reach the light receiving element 50.

Along with rotational driving of the motor, the fifth wheel 20 is rotated in the R2 direction at a high speed. Although it depends on a point of time (the position of the second hand when the command for setting the initial positions is issued), the rotation of the fifth wheel 20 is decelerated and is transmitted to the fourth wheel 10 and hence, typically, even when the fifth wheel 20 which is rotated at a high-speed in the R2 direction after receiving the setting command reaches the initial position Si2, the fourth wheel 10 does not readily reach the initial position Si1. In this case, even when the elongated hole 24 is positioned at the rotational position where the elongated hole 24 obliquely faces the reflection mirror 60, the wall portion of the fourth gear portion 12 of the fourth wheel 10 having no elongated hole 14 blocks the optical path Pi of the emitted beam Bi of the light emitting element 40 and hence, the beam Bi from the light emitting element 40 is not incident on the reflection mirror 60 whereby the beam Bi is not detected even by the light receiving element 50.

On the other hand, during the fifth wheel 20 is rotated several times, the fifth wheel 20 reaches the initial position Si2 and, at the same time, the fourth wheel Si1 reaches the initial position. At this point of time, the elongated hole 14 formed in the fourth gear portion 12 of the fourth wheel 10 and the elongated hole 24 formed in the fifth gear portion 22 of the fifth wheel 20 are just overlapped to each other and hence, the beam B1 emitted from the light emitting face 42 of the light emitting element 40 passes through incident optical path parts 17, 27 at one end sides of the elongated holes 14, 24 along the incident optical path Pi and reaches the reflection face 61 of the reflection mirror 60. Then, the beam Bi is reflected on the reflection face 61 and reaches and is received by the light receiving face 52 of the light receiving element 50 after passing through another-end-side reflection optical path part 28 of the elongated hole 24 of the fifth gear portion 22 and another-end-side reflection optical path part 18 of the elongated hole 14 of the fourth gear portion 12 along the reflection optical path Pr as the reflecting beam Br and hence, it is detected that the fifth gear 20 and the fourth gear 10 reach the initial positions Si2, Si1 whereby the motor 30 is temporarily stopped, for example. In this manner, the fourth wheel 10 is set to the initial position Si1 such that the second hand assumes the just 12 o'clock. The positioning accuracy for setting the fourth wheel 10 to the initial position (the angular resolution with respect to a state in which the fourth wheel 10 assumes the initial position) can be easily enhanced such that the height becomes at least 1 unit (6 degree, that is, −3 degree to +3 degree), for example, by setting the fifth wheel 20 to the initial position Si2.

As described above, in the hand position detection device 1, since the light emitting element 40 and the light receiving element 50 are not arranged close to each other but are arranged sufficiently spaced-apart from each other and hence, there is a small possibility that the beam transmitted from the light emitting face 42 of the light emitting element 40 directly or indirectly enters the light receiving face 52 of the light receiving element 50 as a stray light after passing through an optical path other than the optical paths Pi, Pr for given beams Bi, Br. Further, the light emitting element 40 and the light receiving element 50 are arranged in the inside of the separate recessed portions (openings) 7, 8 such that the light emitting face 42 and the light receiving face 52 are positioned in regions surrounded by peripheral walls and hence, the possibility that light from the light emitting element 40 is erroneously received by the light receiving element 50 is small. Further, in this hand position detection device 1, the distance D between the light emitting element 40 and the light receiving element 50 becomes substantially equal compared to the distance (the width of the gap G) between the portion where the light emitting element 40 and the light receiving element 50 are disposed and the reflection mirror 60 and hence, the optical paths Pi, Pr which reach the light receiving element 50 from the light emitting element 40 after passing through the reflection mirror 60 assume a V shape having a sufficient reflection angle whereby the possibility that the light receiving element 50 erroneously receives light from the light emitting element 40 can be minimized. In this hand position detection device 1, the direction which connects the light emitting element 40 and the light receiving element 50 (that is, the extending direction of an imaginary line V1 which connects the incident optical path part 17 and the reflection optical path part 18 of the elongated hole 14 of the fourth wheel 10 and the extending direction of an imaginary line V2 which connects the incident optical path part 27 and the reflection optical path 28 of the elongated hole 24 formed in the fifth wheel 20) is the Y direction and is set to the direction orthogonal to the direction X which connects axis 11, 21. Accordingly, even when the distance D between the light emitting element 40 and the light receiving element 50 is increased, the width W1 between the elongated holes 14, 24 can be held at a small value and hence, it is not necessary to increase the distance between the axis 11, 21 whereby there is no possibility that the device becomes large-sized. Here, the imaginary line V1 or V2 and the line which connects the axis 11, 21 may be oblique to each other instead of being or thogonal to each other. However, an angle α made by both lines may be preferably at least 30 degrees or more, more preferably 45 degrees or more and still more preferably 60 degrees or more. Further, typically, the angle α is substantially 90 degrees as illustrated. Since the incident optical path parts 17, 27, the reflection-optical path parts 18, 28, the imaginary lines V1, V2 and the angle C may obstruct the easiness of understanding of drawings and hence, these are not explained in the drawings hereinafter. However, following embodiments have the substantially same constitution. Further, since the light emitting element 40 and the light receiving element 50 are not arranged between the axis 11, 21, the axis 11, 21 can be arranged close to each other as much as possible within a range which is necessary for ensuring the original operation of the fourth wheel 10 and the fifth wheel 20 so that the device can be miniaturized.

Here, it is preferable that the direction which connects the light emitting element 40 and the light receiving element 50 is typically the direction which is orthogonal to the X direction as in the case of this embodiment. However, provided that the direction which connects the light emitting element 40 and the light receiving element 50 is the direction which intersects the X direction, the direction may be not orthogonal to the X direction.

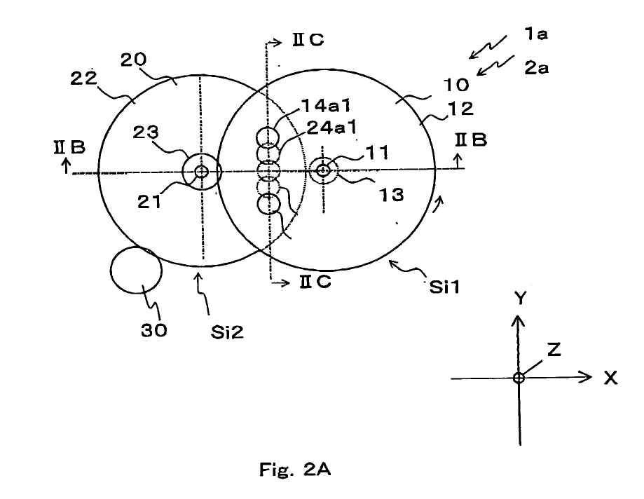

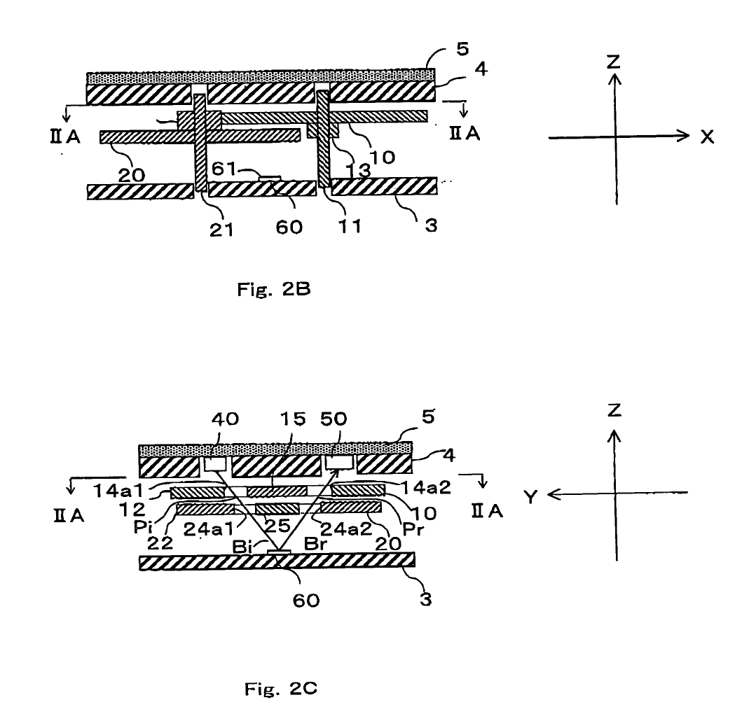

Next, a hand position detection device 1a which constitutes a rotational position detection device of the preferred second embodiment of the present invention is explained in conjunction with FIG. 2. In the hand position detection device 1a shown in FIG. 2, components and parts which are similar to those shown in FIG. 1 are given same symbols used in FIG. 1.

In the hand position detection device 1a of the watch 2a shown in FIG. 2, the fourth wheel 10 and the fifth wheel 20 include, in place of the elongated holes 14 and 24, a pair of small holes 14a1, 14a2 (indicated by symbol 14a in a generic term) and a pair of small holes 24a1, 24a2 (indicated by symbol 24a in a generic term). To be more specific, the small holes 14a1, 14a2 are formed at the positions which correspond to both end portions of the elongated hole 14 shown in FIG. 1, while the small holes 24a1, 24a2 are formed at the positions which correspond to both end portions of the elongated hole 24 shown in FIG. 1.

In this hand position detection device 1a, when the fourth gear 10 and the fifth gear 20 are rotated to the initial positions Si1, Si2 where the small holes 14a1 and the small holes 24a1 are arranged in a row to open the incident optical path Pi for the incident light Bi leading from the light emitting element 40 to the reflection mirror 60 and the small holes 24a2 and the small holes 14a2 are arranged in a row to open the reflection optical path Pr for reflection light Br leading from the reflection mirror 60 to the light receiving element 60 and hence, it is detected that the light from the light emitting element 40 is received by the light receiving element 60 and both gears 10, 20 reach the initial positions Si1, Si2. That is, when both gears 10, 20 assume the respective initial positions, the small holes 14a1 and the small holes 24a1 are positioned at the incident optical path parts 17, 27 of the fourth wheel 10 and the fifth wheel 20, while the small holes 24a2 and the small holes 14a2 are positioned at the reflection optical path parts 28, 18.

In this hand position detection device 1a in which the fourth wheel 10 and the fifth wheel 20 are respectively provided with pairs of small holes 14a1, 14a2 and 24a1, 24a2, a light shielding wall portion 15 is arranged between the small hole 14a1 and the small hole 14a2 and a light shielding wall portion 25 is arranged between the small hole 24a1 and the small hole 24a2 and hence, when the fourth wheel 10 and the fifth wheel 20 are slightly displaced from the respective initial positions Si1, Si2, blocking of the optical paths Pi, Pr of the beam Bi, Br can be easily performed using the shielding wall portions 15, 25 whereby the positioning accuracy can be easily enhanced. That is, in this hand position detection device 1a, the small holes 14a, 24a finely define the optical path Pr which can reach the light receiving element 50 from the light emitting element 40 by way of the reflection mirror 60 and hence, even when light which is irradiated from the light emitting element 40 is scattered or reflected in random directions at some places in the inside of the watch 2a and a stray light is generated, except for a case in which both wheels 10, 20 assume the initial positions Si1, Si2, the possibility that the stray light is received by the light receiving element 50 with high intensity is small whereby the erroneous operation can be suppressed to a minimum level. Accordingly, the hand position detection device 1a can enhance the angular resolution.

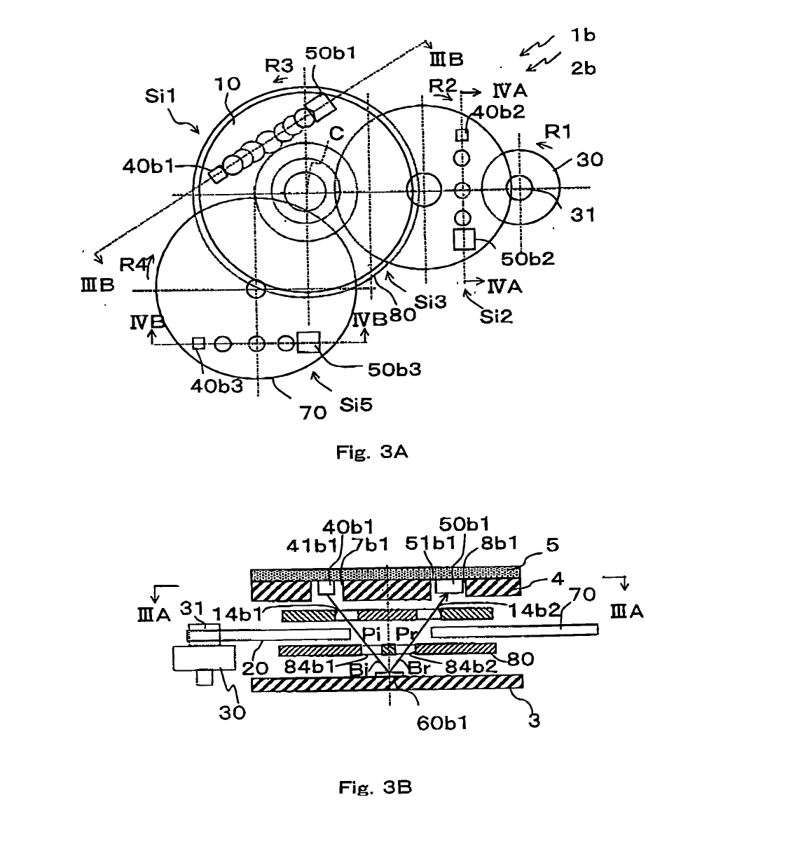

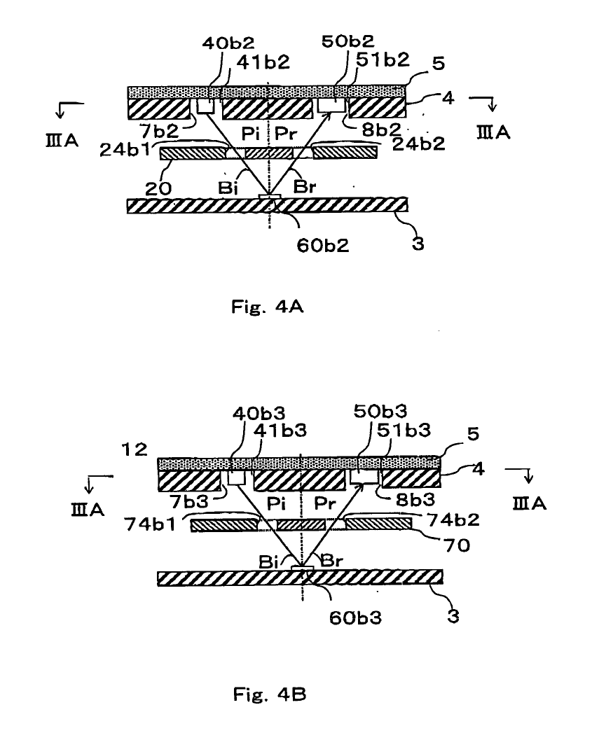

Next, a hand position detection device 1b which constitutes a rotational position detection device of the preferred third embodiment of the present invention is explained in conjunction with FIG. 3 and FIG. 4. In the hand position detection device 1a shown in FIG. 3 and FIG. 4, components and parts which are similar to those shown in FIG. 1 and FIG. 2 are given same symbols used in FIG. 1 and FIG. 2.

In the hand position detection device 1b of a watch 2b shown in FIG. 3 and FIG. 4, besides the fact that the second hand (in other words, the second hand wheel or the fourth wheel) assumes the initial position, the fact that the minute hand (in other words, the minute hand wheel or the second wheel) assumes the initial position is also detected.

In FIG. 3 and FIG. 4, the watch 2b includes a third wheel 70 and a second wheel 80. To be rotatable about the center axis C in the same manner as the fourth wheel 10, the second wheel 80 includes a center axis 81 thereof, a second gear 82 thereof which is formed in a large-diameter disc shape, and a small gear or a pinion portion 83 which is formed in a small-diameter disc shape and a second hand (not shown in the drawing) is mounted on one end of the center axis 81. The third wheel 70 includes a center axis 71 thereof, a third gear 72 thereof which is formed in a large-diameter disc shape, and a small gear or a pinion portion 73 which is formed in a small disc shape, wherein the third gear 72 is meshed with the pinion portion 13 of the fourth wheel 10 and the pinion portion 73 of the third wheel 70 is meshed with the second gear 82, whereby the third wheel 70 is rotated in the R4 direction in response to the rotation of the second hand wheel (fourth wheel) 10 in the R3 direction so that minute hand wheel (second wheel) 80 is rotated in the R3 direction at a rate of one revolution per hour. In this embodiment, for example, it may be considered that the fourth wheel 10 and the second wheel 80 correspond to the first and the second disc-like rotary bodies, while at least one of the fifth wheel 20 and the third wheel 70 corresponds to the fourth disc-like rotary body. Here, it is also considered that another wheel out of the fifth wheel 20 and the third wheel 70 corresponds to the fourth disc-like rotary body.

In the hand position detection device 1b, to detect that the second hand wheel (the fourth wheel) 10 and the minute hand wheel (the second wheel) 80 are just overlapped to each other at the initial positions Si1, Si3, the fourth wheel 12 is provided with a pair of small holes 14b1, 14b2 in a chord direction thereof, while the second wheel 82 is provided with a pair of small holes 84b1, 84b2 in a chord direction thereof. At the same time, in the inside of the light receiving element receiving opening 7b1 and the light emitting element receiving opening 8b1 of the gear train acceptor 4, a light emitting element 40b1 and a light receiving element 50b1 are arranged at portions 41b1 and 51b1 of the printed circuit board S and a reflection mirror 60b1 is formed at a given position of the base plate 3. Accordingly, so long as the second hand wheel (the fourth wheel) 10 and the minute hand wheel (the second wheel) 80 assume the initial positions Si1, Si3, light emitted from the light emitting element 40b1 passes through the small holes 14b1, 84b1 and reaches the reflection mirror 60b1. Then, after being reflected on the reflection mirror 60b1, the light passes through the small holes 84b2, 14b2 and is received by the light receiving element 50b1.

Further, in the hand position detection device 1b, to detect that the second hand wheel (the fourth wheel) 10 is accurately positioned at the initial position Si1, the fifth wheel 20 which is rotated at a high speed compared to the fourth wheel 10 is provided with a pair of small holes 24b1, 24b2 in a chord direction thereof. At the same time, in the inside of the light emitting element receiving opening 7b2 and the light receiving element receiving opening 8b2 of the gear train acceptor 4, a light emitting element 40b2 and a light receiving element 50b2 are arranged at portions 41b2 and 51b2 of the printed circuit board 5 and a reflection mirror 60b2 is formed at a given position of the base plate 3. Accordingly, so long as the second hand wheel (the fourth wheel) 10 is accurately positioned at the initial positions Si1, light emitted from the light emitting element 40b2 passes through the small holes 24b1 and reaches the reflection mirror 60b2. Then, after being reflected on the reflection mirror 60b2, the light passes through the small holes 24b2 and is received by the light receiving element 50b2. Accordingly, it is possible to easily ensure the angular resolution (for example, 6 degree or less) of the second hand.

Further, in the hand position detection device 1b, to detect that the minute hand wheel (second wheel) 80 is accurately positioned at the initial position Si3, the third wheel 70 which is rotated at a high speed compared to the second wheel 80 is provided with a pair of small holes 74b1, 74b2 in a chord direction thereof. At the same time, in the inside of the light emitting element receiving opening 7b3 and the light receiving element receiving opening 8b3 of the gear train acceptor 4, a light emitting element 40b3 and a light receiving element 50b3 are arranged at portions 41b3 and 51b3 of the printed circuit board 5 and a reflection mirror 60b3 is formed at a given position of the base plate 3. Accordingly, so long as the minute hand wheel (second wheel) 80 is accurately positioned at the initial position Si3 (the third wheel 70 also assumes the initial position Si5), light emitted from the light emitting element 40b3 passes through the small holes 74b1 and reaches the reflection mirror 60b3. Then, after being reflected on the reflection mirror 60b3, the light passes through the small holes 74b2 and is received by the light receiving element 50b3. Accordingly, it is possible to easily ensure the angular resolution (for example, 6 degrees or less) of the minute hand.

In this hand detection device 1b, it is possible not only to suppress the generation of error attributed to the stray light to a minimum level at the time of detecting the positions using the V-shaped optical paths Pi, Pr each of which utilizes a pair of small holes but also to easily confirm that the second hand wheel 10 and the minute hand wheel 80 are at the initial positions in response to the detection of the rotational positions of the fifth wheel 20 and the third wheel 70 which are rotated at high speeds compared to the second hand wheel 10 and the minute hand wheel 80. Accordingly, it is possible to enhance the accuracy of detection of the initial positions. At the same time, by adopting the mode of operation in which the wheels 10, 80 are not considered to assume the initial positions unless three types of position detections are performed simultaneously, it is possible to obviate the erroneous operation attributed to the stray light even when any one of them performs the erroneous detection operation attributed to the stray light.

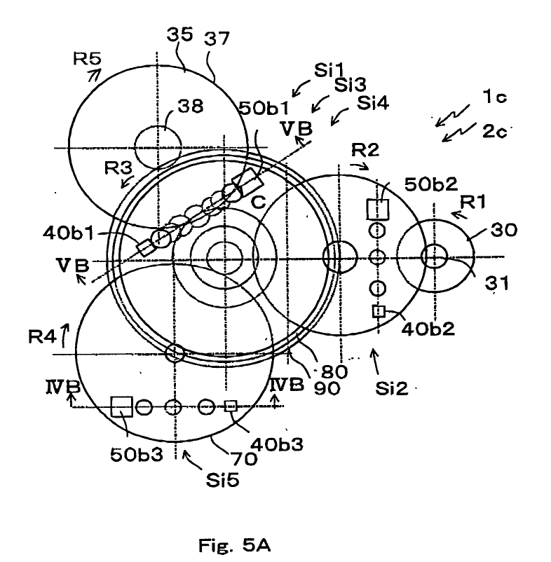

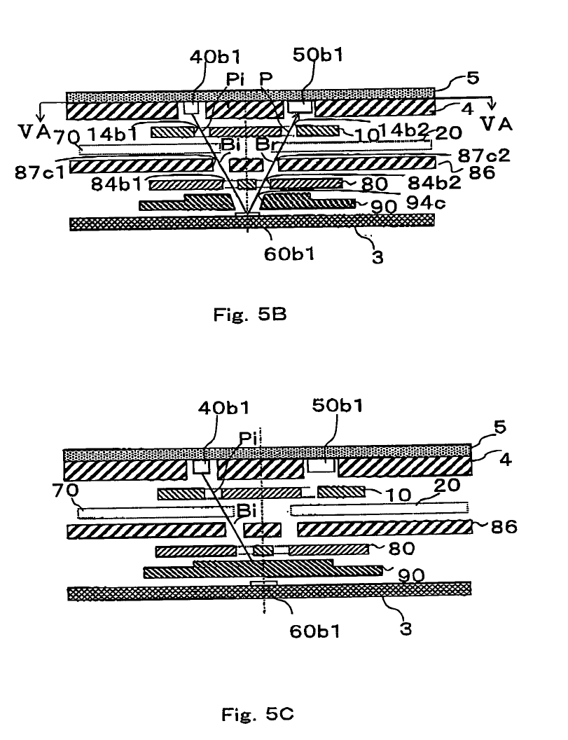

Next, a hand position detection device 1c which constitutes a rotational position detection device of the preferred fourth embodiment of the present invention is explained in conjunction with FIG. 5. In the, hand position detection device 1c shown in FIG. 5, components and parts which are similar to those shown in FIG. 1 to FIG. 4 are given same symbols used in FIG. 1 to FIG. 4.

In the hand position detection device 1c of a watch 2c shown in FIG. 5, not only the fact that the second hand (in other words, the second hand wheel or the fourth wheel) and the minute hand (in other words, the minute hand wheel or the second wheel) assume the initial positions but also the fact that the hour hand (in other words, the hour hand wheel or the cylindrical wheel) assumes the initial position are detected.

In FIG. 5, the watch 2c includes a rear wheel 35 for a day and an hour hand wheel 90, while a rotational center axis 81 of a second wheel 80 is rotatably supported by a second acceptor 86 at one end side of the watch 2c. To be rotatable about the center axis C in the same manner as the fourth wheel 10 and the second wheel 80, the hour hand wheel 90 includes a center axis 91 thereof, an hour hand gear 92 thereof which is formed in a large-diameter disc shape, and a small gear or a pinion portion 93 which is formed in a small-diameter disc shape and an hour hand (not shown in the drawing) is mounted on one end of the center axis 91. The rear wheel 35 for a day includes a center axis 36 thereof, a rear gear 37 for a day which is formed in a large-diameter disc shape, and a small gear or a pinion portion 38 which is formed in a small-diameter disc shape, wherein the rear gear 37 for a day is meshed with the pinion portion 83 of the second wheel 80 and the pinion portion 38 of the rear wheel for a day is meshed with the hour hand gear 92, whereby the rear wheel 35 for a day is rotated in the R5 direction in response to the rotation of the minute hand wheel (the second wheel) 80 in the R3 direction so that the hour hand wheel 90 is rotated in the R3 direction at a rate of one revolution per 12 hours.

In this hand position detection mechanism 1c, the second receiver 86 includes a small hole 87c1 in the optical path Pi leading from the light emitting element 40b1 to the reflection mirror 60b1 and small hole 87c2 in the optical path Pr leading from the reflection mirror 60b1 to the light receiving element 50b1. Further, the hour hand gear 92 of the hour hand wheel 90 includes a frusto-conical hole or opening 94c which allows the incidence of light Bi to the reflection mirror 60b1 from the light emitting element 40b1 and the incidence of reflecting light Br to the light receiving element 50b1 from the reflection mirror 60b1 when the hour hand wheel 90 is at the initial position Si4.

Accordingly, in the hand position detection mechanism 1c of the watch 2c, provided that the second hand wheel (the fourth wheel) 10, the minute hand wheel (the second wheel) 80 and the hour hand wheel 90 assume the initial positions Si1, Si3, Si4, light irradiated from the light emitting element 40b1 passes through the small holes 14b1, 87c1, 84b1 and the frusto-conical hole 94c, reaches the reflection mirror 60b1, and is reflected on the reflection mirror 60b1. Thereafter, the light passes through the frusto-conical small hole 94c again and, further, passes through the small holes 84b2, 87c2 and 14b2 and is received by the light receiving element 50b1.

Further, in this hand position detection device 1c, in the same manner as the hand position detection device 1b, so long as the second hand wheel (the fourth wheel) 10 is accurately positioned at the initial positions Si1, as shown in FIG. 5B, light emitted from the light emitting element 40b2 passes through the small holes 24b1 and reaches the reflection mirror 60b2. Then, after being reflected on the reflection mirror 60b2, the light passes through the small holes 24b2 and is received by the light receiving element 50b2. Further, so long as the minute hand wheel (second wheel) 80 is accurately positioned at the initial positions Si3, light emitted from the light emitting element 40b3 passes through the small holes 74b1 and reaches the reflection mirror 60b3. Then, after being reflected on the reflection mirror 60b3, the light passes through the small holes 74b2 and is received by the light receiving element 50b3.

Here, in the hand position detection device 1c, as can be clearly understood by comparing FIG. 5 and FIG. 3, the positions of the light emitting element 40b2 and the light receiving element 50b2 become opposite to the positions of these elements in the case of the hand position detection device 1b and, at the same time, the positions of the light emitting element 40b3 and the light receiving element 50b3 become opposite to the positions of these elements in the case of the hand position detection device 1b. However, both relative positions can be adopted.

Also in this hand position detection device 1c, in the same manner as the hand position detection device 1b, it is possible not only to suppress the generation of error attributed to the stray light to a minimum level at the time of detecting the positions using the V-shaped optical path which utilizes a pair of small holes but also to easily confirm that the second hand wheel 10 and the minute hand wheel 80 are at the initial positions in response to the detection of the rotational positions of the fifth wheel 20 and the third wheel 70 which are rotated at high speeds with large angular velocities compared to the second hand wheel 10 and the minute hand wheel 80. Accordingly, it is possible to enhance the accuracy of detection of the initial positions. At the same time, by adopting the mode of operation in which the wheels 10, 80 are not considered to assume the initial positions unless three types of position detections are performed simultaneously, it is possible to obviate the erroneous operation attributed to the stray light even when any one of them performs the erroneous detection operation attributed to the stray light. Here, when the rotational driving is performed using one motor, there is no problem even when the angular resolution is low (30 degree or less) with respect to a clock and hence, in this embodiment, the reflection face 60b1 is provided at a side close to the cylindrical wheel (the hour hand wheel) 90 and no auxiliary position detection is performed with respect to the cylindrical wheel 90.

Here, in the hand position detection mechanism 1c of the watch 2c, for example, even when the second hand wheel 10 and the minute hand wheel 80 assume the initial positions Si1, Si3, so long as the hour hand wheel 90 is not arranged at the initial position Si4, as shown in FIG. 5C, the incidence of the incident light Bi to the reflection mirror 60b1 is blocked by the wall portion of the hour hand gear 92 of the hour hand wheel 90 and hence, light from the light emitting element 40b1 is not received by the light receiving element 50b1.

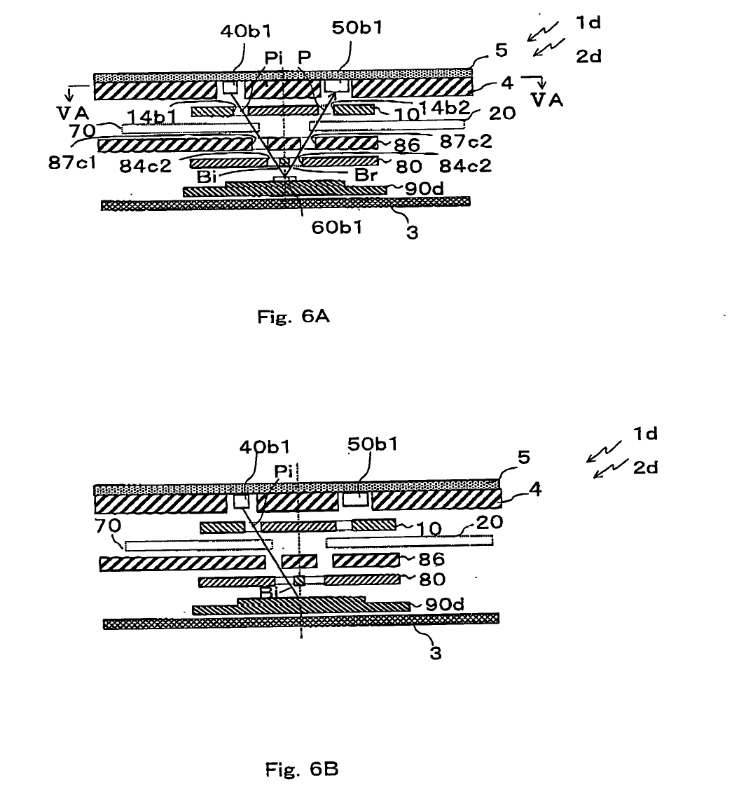

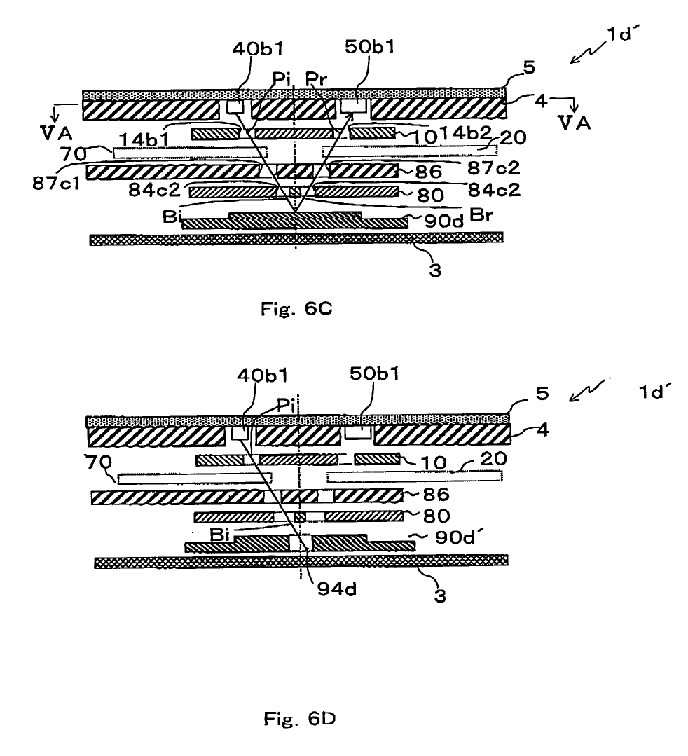

Next, a hand position detection device 1d which constitutes a rotational position detection device of the preferred fifth embodiment of the present invention is explained in conjunction with FIG. 6. In the hand position detection device 1d shown in FIG. 6, components and parts which are similar to those shown in FIG. 1 to FIG. 5 are given same symbols used in FIG. 1 to FIG. 5, This hand position detection device 1d differs from the hand position detection device 1c of the fourth embodiment in that the reflection mirror is not formed on the surface of the base plate but is formed on a surface of an hour hand wheel. Accordingly, in FIG. 6, to clarify the different point, a drawing to be compared with FIG. 5B is shown as FIG. 6A and a drawing to be compared with FIG. 5C is shown as FIG. 6B. Here, it may be considered that a plan (cross-sectional) view of the hand position detection device 1d of the fifth embodiment is shown in FIG. 5A.

With respect to the hand position detection devices 1d and 1d′ of the watch 2d shown in FIG. 6, different from the hand position detection device 1c shown in FIG. 5, in place of providing the frusto-conical small hole 94c to the hour hand wheel 90 and forming the reflection mirror 60 to the base plate 3, a reflecting portion is formed on an hour hand wheel 90d. Accordingly, the whole constitution of the hour hand wheel 90d and the base plate 3 can be simplified thus realizing the reduction of cost.

Accordingly, in the hand position detection mechanism 1d of the watch 2d, as shown in FIG. 6A, provided that the second hand wheel (the fourth wheel) 10, the minute hand wheel (the second wheel) 80 and the hour hand wheel 90d assume the initial positions Si1, Si3, Si4, light irradiated from the light emitting element 40b1 passes through the small holes 14b1, 87c1 and 84b, reaches the reflection mirror 60d1 on the hour hand wheel 90d which is arranged at the initial position Si4, and is reflected on the reflection mirror 60d1. Thereafter, after being reflected on the reflection mirror 60d1, the light passes through the small holes 84b2, 87c2 and 14b2 and is received by the light receiving element 50b1.

Here, to describe in detail, the hand position detection device 1d differs from the hand position detection device 1c in that, in the hand position detection device 1d, assuming that the size (the width) of a gap G defined between the printed circuit board 5 and the base plate 3 is equal to the corresponding size in the case of the hand position detection device 1c shown in FIG. 5, the direction of the incident light Bi leading from the light emitting element 40b1 to the reflection face of the reflection mirror 60d1 and the direction of the reflection light Br leading from the reflection face of the reflection mirror 60d1 to the light receiving element 50b1 are changed (an incident angle and a reflection angle on the reflection face being increased) and hence, respective pairs of small holes 14b1 and 14b2, the small holes 87c1 and 87c2 and the small holes 84b1 and 84b2 which are to be formed in the fourth wheel 10, the second receiver 86 and the second wheel 80 are positioned such that the respective distances between the small holes 14b1 and 14b2, between the small holes 87c1 and 87c2 and between the small holes 84b1 and 84b2 become slightly smaller.

In the hand position detection mechanism 1d of the watch 2d, for example, even when the second hand wheel 10 and the minute hand wheel 80 are at the initial positions Si1, Si3, when the hour hand wheel 90 is not at the initial position Si4, as shown in FIG. 6B, the incident light Bi impinges on a surface region of the hour hand wheel 90d having no reflection mirror 60d1 and hence, the reflection light from the hour hand wheel 90d is not substantially obtained whereby the light from the light emitting element 40b1 is not received at the light receiving element 50b1.

Here, in the hand position detection mechanism 1d′ of the watch 2d′ shown in FIGS. 6 A, B, the reflection mirror is arranged only on a portion of the hour hand wheel 90d and other portions of the hour hand wheel 90d are formed into non-reflection portions and hence, only when the hour hand wheel is at the initial position, the reflection light reaches the light receiving element 50b1. However, as shown in FIGS. 6C, D, even when the hour hand wheel 90d′ is constituted such that only a portion of the hour hand wheel (the small hole 94d being formed as an example) is formed into a non-reflective face, and other portions of the hour hand wheel constitute reflection faces, wherein the light reaches the light receiving element 50b1 when the second hand wheel and the minute hand wheel are at the initial position and the hour hand wheel is at the position other than the initial position, and the light does not reach the light receiving element 50b1 when the second hand wheel, the minute hand wheel and the hour hand wheel are at the initial position, it is possible to substantially detect the initial positions of the hands.

Here, in the constitutions shown in FIGS. 6C, D, the non-reflective portions are formed on the surface 95 of the hour hand wheel after performing the reflection treatment such as plating, polishing, sputtering or the like and hence, it is possible to manufacture the hour hand wheel having high light reflectance at a relatively low cost.

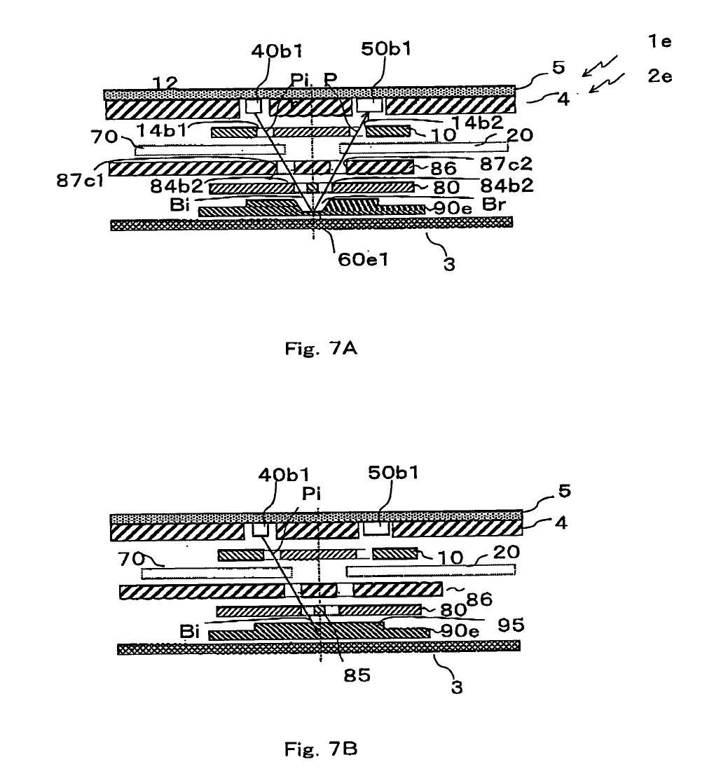

Next, a hand position detection device 1e which constitutes a rotational position detection device of the preferred sixth embodiment of the present invention is explained in conjunction with FIG. 7. In the hand position detection device 1e shown in FIG. 7, components and parts which are similar to those shown in FIG. 1 to FIG. 6 are given same symbols used in FIG. 1 to FIG. 6.

This hand position detection device 1e differs from the hand position detection device 1d of the fifth embodiment with respect to a point that the reflection face is not formed on a main surface of the hour hand wheel but is formed on a bottom face of a recessed portion formed in the main surface.

In the hand position detection device 1e of the watch 2e shown in FIG. 7, different from the hand position detection device 1c shown in FIG. 6, no special reflection mirror is used, wherein the reflection face 61e1 is not formed on the main surface 95 of the hour hand wheel 90e but is formed on a portion of the main surface 95. That is, the reflection face 61e1 is formed on a bottom face 97 of a frusto-conical recessed portion 96 corresponding to the initial position of the hour hand wheel. Here, in this embodiment, a gap defined between the main surface 95 and the second wheel which faces the main surface 95 is set as small as possible while a distance between the main surface 95 and the bottom face 97 of the recessed portion 96 is set as large as possible. The center position of the reflection face 61e1 is, when viewed in a plan view as shown in FIG. 5A, substantially aligned with the center position of the reflection face of the reflection mirror 60d of the hour hand wheel 90d1 of the hand position detection device 1d.

Accordingly, in the hand position detection mechanism 1e of the watch 2e, only when the second hand wheel (the fourth wheel) 10, the minute hand wheel (the second wheel) 80 and the hour hand wheel 90e are respectively at the initial positions Si1, Si3, Si4 as shown in FIG. 7A, light irradiated from the light emitting element 40b1 passes through the small holes 14b1, 87c1 and 84b1 and reaches the reflection face 61e1 formed on the bottom face 97 of the recessed portion 96 of the hour hand wheel 90e at the initial position Si4. Then, after being reflected on the reflection face 61e1, the light passes through the small holes 84b2, 87c2, 14b2 and is received by the light receiving element 50b1.

Here, to describe in detail, the hand position detection device 1e differs from the hand position detection device 1d in that, in the hand position detection device 1e, assuming that the size (the width) of a gap G defined between the printed circuit board 5 and the base plate 3 is equal to the corresponding size in the case of the hand position detection device 1d shown in FIG. 6, the direction of the incident light Bi leading from the light emitting element 40b1 to the reflection face 60e1 and the direction of the reflection light Br leading from the reflection face 61d1 to the light receiving element 50b1 are changed (an incident angle and a reflection angle on the reflection face being decreased) and hence, respective pairs of small holes 14b1 and 14b2, the small holes 87c1 and 87c2 and the small holes 84b1 and 84b2 which are to be formed in the fourth wheel 10, the second receiver 86 and the second wheel 80 are positioned such that the respective distances between the small holes 14b1 and 14b2, between the small holes 87c1 and 87c2 and between the small holes 84b1 and 84b2 become slightly larger.

In the hand position detection mechanism 1e of the watch 2e, for example, even when the second hand wheel 10 and the minute hand wheel 80 are at the initial positions Si1, Si3, when the hour hand wheel 90 is not at the initial position Si4, as shown in FIG. 7B, the incident light Bi impinges on the surface region having no reflection mirror 60e1, that is, the main surface 95 of the hour hand wheel 90e and hence, the reflection light from the hour hand wheel 90e cannot be substantially obtained. At the same time, assuming that the reflection light from the main surface 95 is generated more or less, an optical path of the reflection light is displaced from the original optical path Pr due to the difference of position in the z direction between the main surface 95 and the bottom face 97 of the recessed portion 96 and hence, the reflection light is surely blocked by the wall portion 85 of the second wheel 80 or the like whereby the possibility that the light from the light emitting element 40b1 is erroneously received by the light receiving element 50b1 can be reduced due to the same constitution shown in FIG. 6. Accordingly, although it is necessary to slightly increase a light emitting quantity of the light emitting element 40b1 and an output of the light receiving element 40b1, the cost for making the main surface 95 rough, the cost for performing mirror finish treatment of the reflection part 61e1 and the cost for forming the reflection mirror 60e1 becomes unnecessary.

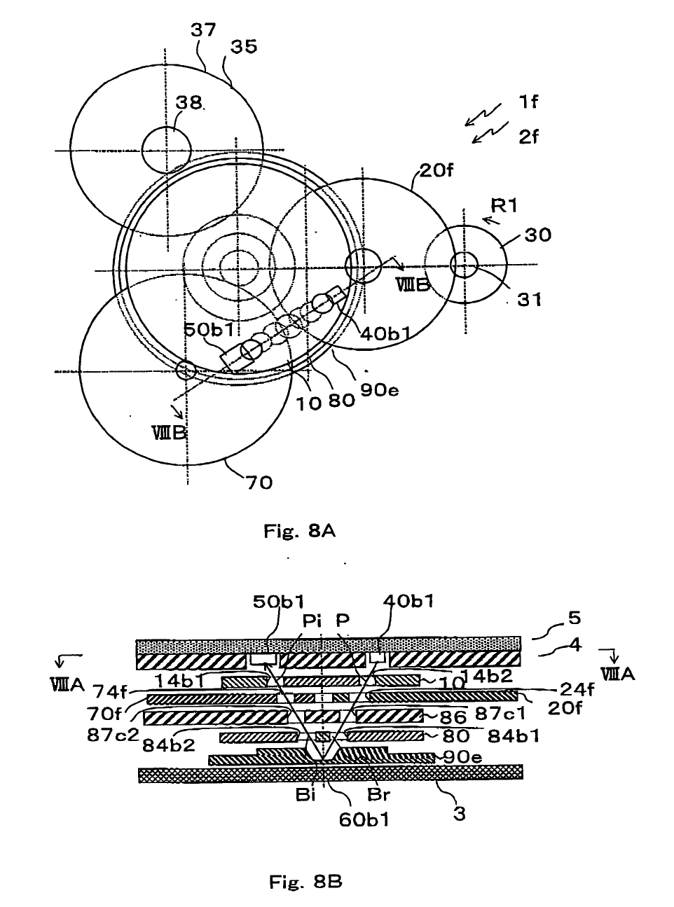

Next, a hand position detection device if which constitutes a rotational position detection device of the preferred seventh embodiment of the present invention is explained in conjunction with FIG. 8. In the hand position detection device if shown in FIG. 8, components and parts which are similar to those shown in FIG. 1 to FIG. 7 are given same symbols used in FIG. 1 to FIG. 7.

This hand position detection device if differs from the hand position detection device 1e shown in FIG. 7 in that in place of providing three sets of combinations each consisting of the light emitting element, the light receiving element and the reflection mirror, using a set of the light emitting element 40b1, the light receiving element 50b1 and the reflection mirror 60e1, it is possible to detect that the fifth wheel and the third wheel are at the initial positions Si2, Si5 in addition to that the fourth wheel (the second hand wheel) 10, the second wheel (minute hand wheel) 80 and the hour had wheel 90 are respectively at the initial positions Si1, Si3, Si4.

To be more specific, in the hand position detection device 1f of the watch 2f shown in FIG. 8, the fifth wheel 20f and the third wheel 70f are respectively provided with one small hole 24f and one small hole 74f such that the fact that the fifth wheel 20f and the third wheel 70f are respectively at the initial positions Si2, Si5 can be detected. That is, in the hand position detection device 1f, when the fourth wheel (the second hand wheel) 10, the second wheel (the minute hand wheel) 80 and the hour hand wheel 90 are respectively at the initial positions Si1, Si3, Si4 and the fifth wheel 20f and the third wheel 70f are at the initial positions Si2, Si5, as shown in FIG. 8B, light from the light emitting element 40b1 passes through the small hole 14b1 formed in the fourth wheel 10 at the initial position Si1 and, thereafter, passes through the small hole 24f formed in the fifth wheel 20f at the initial position Si2. Further, the light passes through the small hole 87c1 formed in the second receiver 86 and, thereafter, passes through the small hole 84b1 formed in the second wheel 80 at the initial position Si3 and is incident on the reflection face 61e1 of the reflection mirror 60e3 at a recessed portion 96 formed in the hour hand wheel 90e at the initial position Si4 as the incident light Bi. Then, the light is reflected on the reflection face 61e1 as the reflection light Br and passes through the small hole 84b2 formed in the second wheel 80 at the initial position Si3 and, thereafter passes through the small hole 87c2 formed in the second receiver 86. Further, the light passes through the small hole 74f formed in the third wheel 70f at the initial position Si5 and, thereafter, passes through the small hole 14b2 formed in the fourth wheel 10 at the initial position Si1 and is received by the light receiving element 50b1.

According to this hand position detection device 1f, it is sufficient to prepare only one set of light emitting element 40b1, the light receiving element 50b1 and the reflection mirror 60e1 and hence, the device can be miniaturized and simplified.

Here, the hand position detection device 1f also differs from the hand position detection device 1e which is arranged in the layout shown in FIG. 5A with respect to a point that to enable the detection of the fact that the fifth wheel 20 and the third wheel 70 are at the initial position in addition to the fourth wheel 10, second wheel 80 and the hour hand wheel 90 using a set of the light receiving element 50b1, the light emitting element 40b1 and the reflection mirror 60e1, the set of light receiving element 50b1, the light emitting element 40b1 and the reflection mirror 60e1 are arranged at the position where these five wheels can be overlapped to each other.

In this hand position detection device 1f, in case the hour hand wheel 90e is not at the initial position Si4 even when the fourth wheel 10 and the second wheel 80 are at the initial positions Si1, Si3, the light from the light emitting element 40b1 does not impinge on the reflection mirror 60e1 but impinges on the main surface 95 of the hour hand wheel 1o and hence, in the same manner as the hand position detection device 1e, the light receiving element 50b1 does not receive the light.

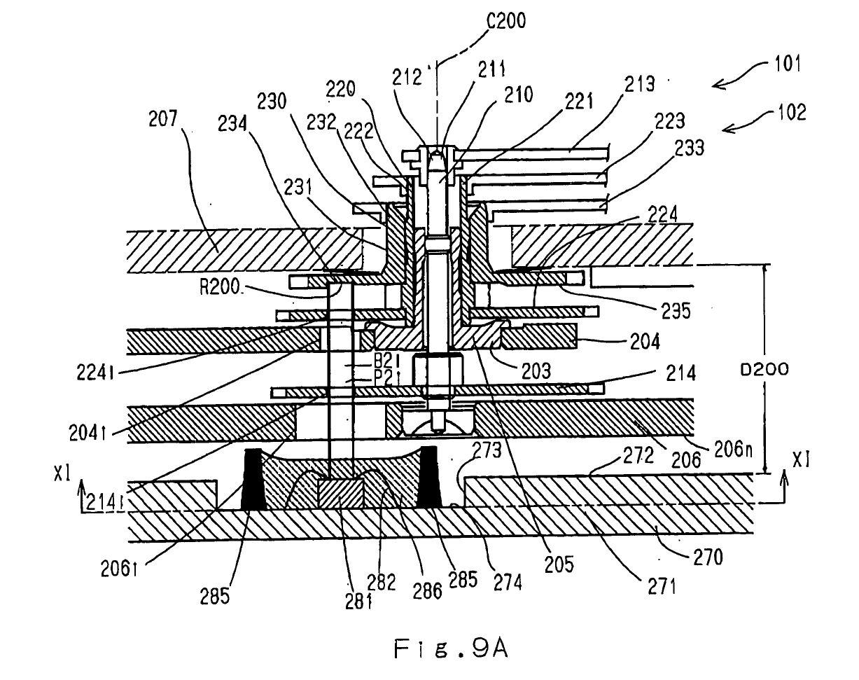

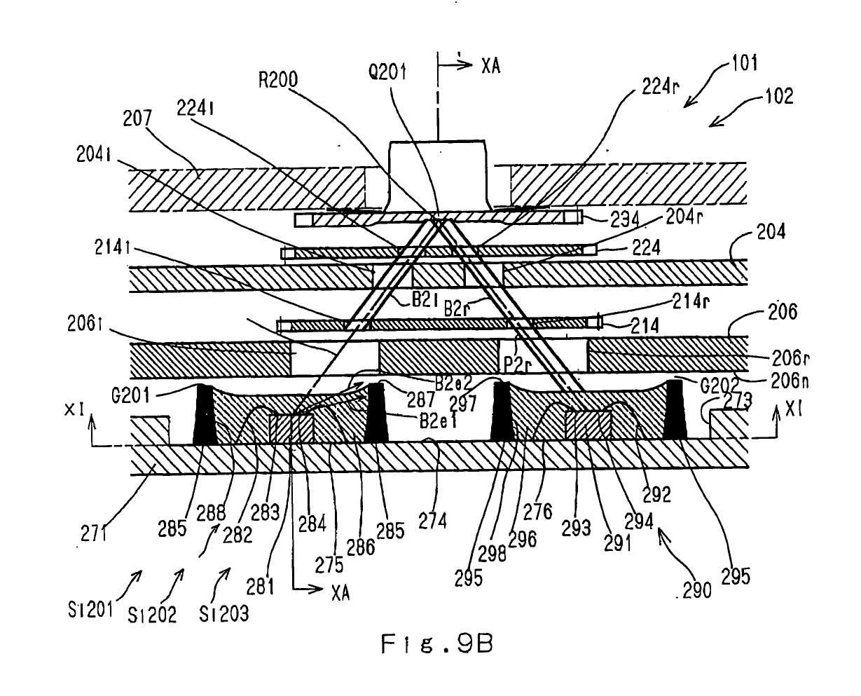

FIG. 9 to FIG. 14 show hand position detection devices 101 and 301 which constitute the rotational detection devices of the preferred embodiments of the present invention having the light shielding structure and watches 102 and 302 provided with the hand position detection devices 101 and 301.

The watch 102 includes a second hand 210, a minute wheel 220 and an hour wheel 230 concentrically about rotational center axis. As shown in FIG. 9A, a second hand 213 is mounted on a distal end 212 of the rotational center axis 211 of the second wheel 210, the minute hand 223 is mounted on a distal end 222 of the rotational center axis 221 of the minute wheel 220, and the hour hand 233 is mounted on a distal end 232 of the rotational center axis 231 of the hour wheel 230.

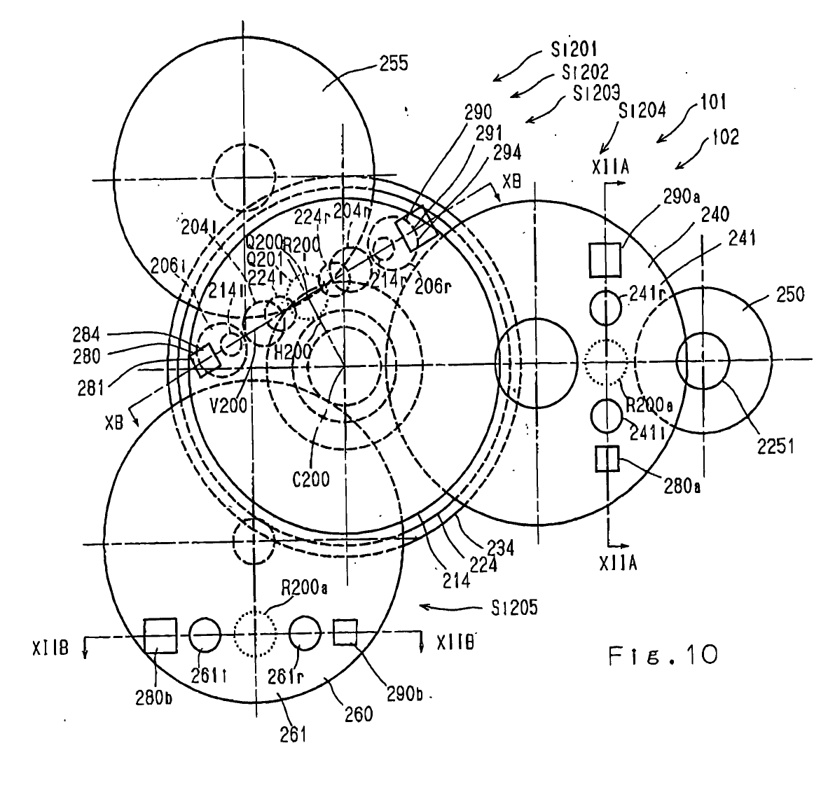

A gear or a fourth gear 214 of the second wheel 210 is coupled to a rotor 251 of a motor 250 by way of a wheel (a gear) such as a fifth gear 240 or the wheel train (the gear train) (see FIG. 10), a gear or a second gear 224 of the minute wheel 220 is coupled to the second wheel 210 by way of a third gear 260 (see FIG. 10), and an hour gear 234 of the hour wheel or the cylindrical wheel 230 is coupled to the minute wheel 220 by way of a rear wheel 255 of a day (see FIG. 10).

A guide pipe 205 which has a flange-like portion 203 thereof supported on a base plate 204 is disposed between the rotational center axis 211 of the second wheel 210 and the cylindrical rotational center axis 221 of the minute wheel 220 so as to support both of them rotatably, while a wheel train acceptor 206 pivotally supports the second wheel 210. Numeral 207 indicates a dial.

A control board 271 which constitutes a printed circuit board of a circuit block 270 includes an elongated recessed portion 273 for mounting a die on one main surface 272 which faces a main surface 206n of the wheel train acceptor 206 on a bottom face 274 of the recessed portion 273, a light emitting element mounting wiring pattern region 275 which constitutes a light emitting element mounting region and a light receiving element mounting wiring pattern region 276 which constitutes a light receiving element mounting region are formed. Here, a thickness of the control board 271 is, for example, approximately 0.3 to 1 mm, while the size of the recessed portion 273 is approximately 1-2 mm×3-5 mm and a depth of the recessed portion 273 is approximately 0.2-0.5 mm.

However, any of these sizes may be increased or decreased.

In the light emitting element mounting wiring pattern region 275, a light emitting element chip 281 formed of an LED or the like is arranged and a lead wire 282 is bonded between a terminal region 283 around a light emitting face 284 of a light emitting element 281 and a terminal portion of the wiring pattern region 275. Around the light emitting element 281, a light shielding wall 285 made of an opaque material is formed such that the light shielding wall 285 surrounds the light emitting element 281 and the light emitting element wiring pattern region 275. The size of the light emitting element chip 281 is approximately 0.3-0.5 mm square, and a thickness of the light emitting element chip 281 is approximately 0.2 mm. A region surrounded by the light shielding wall 285 is, for example, approximately 1 mm×1 mm and a height of the light shielding wall 285 is, for example, approximately 0.5 mm. However, provided that the height of the light shielding wall 285 is greater than a height of a curved top portion of the lead wire 282 (positioned above in FIGS. 9A and B), these sizes may be increased or decreased. The light shielding wall 285 is raised from the bottom portion 274 of the recessed portion 273 and makes a top portion 287 face a counter face 206n of the wheel train acceptor 206 with a minute gap G201 defined therebetween. The light emitting element chip 281 and the lead wire 282 are sealed in a transparent sealing resin 286 which substantially fills a region inside the light shielding wall 285. Here, a printing ink or the like is typically printed on the light shielding wall 285 and the light shielding wall 285 functions as a sealing wall or a sealing frame for the sealing resin 286 and stops the outflow of sealing resin 286 filled in the region surrounded by an inner peripheral face 288 of the light shielding wall 285 on the bottom face 274 of the recessed portion 273. Here, the light emitting part 280 includes the light emitting element 281, the wire 282 and the light shielding wall 285 and substantially further includes the sealing resin 286.

In the same manner, as shown in FIG. 9B, in the light receiving element mounting wiring pattern region 276, a light receiving element chip 291 formed of a photo transistor or the like is arranged and a lead wire 292 is bonded between a terminal region 293 around a light receiving face 294 of a light receiving element 291 and the wiring pattern region 276. Around the light receiving element 291, a light shielding wall 295 made of an opaque material is formed such that the light shielding wall 295 surrounds the light receiving element 291 and the light receiving element wiring pattern region 276. The sizes of the light receiving element 291 and the light shielding wall 295 are substantially equal to those of the light emitting element 281 and the light shielding wall 285, for example. However, provided that the height of the light shielding wall 295 is greater than a height of a curved top portion of the lead wire 292 (positioned above in FIG. 9B), these sizes may be increased or decreased. The light shielding wall 295 is also raised from the bottom portion 274 of the recessed portion 273 and makes a top portion 297 face a counter face 206n of the wheel train acceptor 206 with a minute gap G202 defined therebetween. The light receiving element chip 291 and the lead wire 292 are sealed in a transparent sealing resin 296 which substantially fills a region inside the light shielding wall 295, Here, a printing ink or the like is typically printed on the light shielding wall 295 and the light shielding wall 295 functions as a sealing wall or a sealing frame for the sealing resin 296 and stops the outflow of sealing resin 296 filled in the region surrounded by an inner peripheral face 298 of the light shielding wall 295 on the bottom face 274 of the recessed portion 273. Here, the light receiving part 290 includes the light receiving element 291, the wire 292 and the light shielding wall 295 and substantially further includes the sealing resin 296.

In the above-mentioned constitution, the light shielding walls 285, 295 are arranged close to the light emitting element 281 and the light receiving element 291 and surround the peripheries of the light emitting element 281 and the light receiving element 291 and hence, the light shielding walls 285, 295 perform not only a role to prevent a portion of light from the light emitting part 280 from becoming a stray light and being received by the light receiving part 290 but also a role of a sealing frame (a sealing wall) which stops the sealing resin in a state that the sealing resin has fluidity within a given range at the time of forming the light emitting part 280 and the light receiving part 290. Here, typically, the sealing walls 285, 295 are formed by printing after the lead wires 282, 292 of the light emitting element 281 and the light receiving element 291 are bonded to the given regions 275, 276 of the board 271. However, if desired, the sealing walls 285, 295 may be formed before bonding the wires 282, 292.

It is preferable to make the light shielding walls 285, 295 have the substantially equal height such that both of gaps G201, G202 can be made small. Typically, the size of the gap G201 and the size of the gap G202 are substantially equal. Further, for making the distance D200 between the board surface 272 and a counter face of the dial 207 as small as possible to enable the reduction of thickness of the watch 102, it is preferable that the heights of the light shielding walls 285, 295 are as low as possible provided that the light shielding of the light emitting element chip 281 and the light receiving element chip 291 can be performed while suppressing the gaps G201, G202 to a minimum level. Further, provided that the light shielding walls 285, 295 can seal the sealing resins 286, 296 in desired regions as the sealing walls, to perform the light shielding efficiently, it is preferable that the light shielding walls 285, 295 are formed as close as possible to the related elements 281, 291 and the wires 282, 292 in the peripheries of the related elements 281, 291 and the bonding portions of the lead wires 282, 292 on the board 271.

Planar shapes of the respective light shielding walls 285, 295 can be selected as desired corresponding to planar shapes of the elements 281, 291 which face the planer shapes of the respective light shielding walls 285, 295 and the corresponding wiring patterns 275, 276 such that the respective light shielding walls 285, 295 include them and also the heights thereof can be easily controlled.

Heretofore, the explanation is made such that the light emitting element 281 and the light receiving element 291 are arranged and mounted on the recessed portion 273 of the control board 271. However, when the heights of the light emitting element 281 and the light receiving element 291 are relatively low and the thicknesses of the hand position detection device 101 and the watch 102 are held at a given value or less even when the light shielding walls 285, 295 are set sufficiently higher than the light emitting element 281 and the light receiving element 291, the light receiving element 281 and the light receiving element 291 maybe directly mounted on the main surface 272 of the control board 271. Further, if desired, the recessed portion 273 is formed only for either one of the light emitting element 281m and the light receiving element 291, or either one of the light emitting element 281 and the light receiving element 291 is mounted on the bottom portion 274 of the recessed portion 273 and the other may be mounted on the main surface 272. Further, in this embodiment, although the recessed portion 273 for arranging the light emitting element 281 and the light receiving element 291 is formed of one contiguously elongated recessed portion, the recessed portion for arranging the light emitting element 281 and the recessed portion for arranging the light receiving element 291 may be formed separately. Further, when the board 271 is thick, respective peripheral walls per se of the recessed portion for the light emitting element 281 and the recessed portion for the light receiving element 291 may be used as light shielding walls for the light emitting element 281 and the light receiving element 291. Further, in place of forming the whole light shielding walls 285, 295 as the recessed portion, portions of the light shielding walls 285, 295 may be formed on the main surface 272. Particularly, when the recessed portion for the light emitting element 281 and the recessed portion for the light receiving element 291 are formed separately, the whole light shielding walls 285, 295 may be formed on the main surface 272.

The gap or the distance between the light shielding wall 285 for the light emitting element 281 and the light shielding wall 295 for the light receiving element 291 is set to a length which can obviate the possibility that a stray light of the light emitted from the light emitting element 281 is erroneously received by the light receiving element, 291 by taking the sizes of the gaps G201, G202 between the light shielding walls 285, 295 and the counter faces 206n of the wheel train acceptor 206 into-consideration.

Bere, in the embodiment shown in FIG. 9, the light emitting face 284 of the light emitting element 281 and the light receiving face 294 of the light receiving element 291 are set parallel to the main surface 272 of the control board 271. However, if desired, to enhance the light reception efficiency of the light, the light emitting element 281 and the light receiving element 291 may be arranged obliquely with respect to the main surfaces in the respective arrangement regions such that the light emitting face is directed in the direction substantially orthogonal to the incident optical path P2i of the incident light B2i emitted from the light emitting element 281 or the light receiving face 294 is directed in the direction substantially orthogonal to a reflection optical path P2r of the reflection light B2r. Further, a turn round optical system which directs the light from the light emitting face 284 of the light emitting element 281 to the incident optical path P2i or a shaping optical system which approximates the beam B2i to the parallel B2i may be provided. The same goes for the light receiving element 291. In some cases, a collimate function of beams or the like may be provided to the sealing resins 286, 296 by adjusting shapes or the like of the sealing resins 286, 296 such that surfaces of the sealing resins 286, 296 are formed into a protruded face.

As can be understood from FIGS. 9A and B and FIG. 10 which shows a cross section taken along a line XA-XA in FIG. 9B, the light emitting part 280 and the light receiving part 290 are arranged such that an imaginary line V200 which connects the light emitting element 281 and the light receiving element 291 is directed in the direction orthogonal to the radial direction H200 of the rotational center axis C200 of the watch 102, that is, the rotational center axis C200 of the second wheel 210, the minute wheel 220 and the hour wheel 230 (the direction orthogonal to the radial direction line H200 which connects an intermediate point Q200 of the imaginary line V200 and the center C200). Due to such a constitution, it is possible to arrange the light emitting element 281 and the light receiving element 291 in a spaced-apart manner while obviating the small gears or the pinion portions or the like of the second wheel 210, the minute wheel 220 and the hour wheel 230. Here, if desired, in place of arranging the imaginary line V200 and the radial direction line H200 orthogonal to each other (90 degrees), the imaginary line V200 and the radial direction line H200 may cross each other obliquely. However, an angle made by the imaginary line V200 and the radial direction line H200 may preferably be at least approximately 30 degrees or more, more preferably approximately 45 degrees or more, and still more preferably approximately 60 degrees or more.

A cylindrical gear portion 234 of a cylindrical wheel 230 has a reflection face R200 at a position where the light from the light emitting face 284 of the light emitting element 281 of the light emitting part 280 is obliquely incident through the incident optical path P2i as the incident beam or the incident light B2i in a state that the hour hand 233 is at the initial position Si203, the incident light B2i is obliquely reflected and the reflected light B2r reaches the light receiving face 294 of the light receiving element 291 of the light receiving part 290 through the reflection optical path P2r. To be more specific, the reflection face R200 is formed at a position Q201 where a foot Q200 of a perpendicular H200 which is drawn downwardly from the rotational center c200 is overlapped to the imaginary line V200 which connects the light emitting part 280 and the light receiving part 290 when the cylindrical gear portion 234 is at the initial position Si203 as viewed in a plan view (a planner cross-sectional view) as shown in FIG. 10 with respect to the surface 235 of the cylindrical gear portion 234 at a side which faces the control board 271. Here, if desired, openings for allowing passing of the incident and reflection light beams B2i, B2r are also formed in the cylindrical gear portion 234 and the reflection face R200 may be formed on the dial 207. In this case, the openings formed in the cylindrical gear portion 234 for allowing passing of the incident and reflection light beams B2i, B2r may be formed of a single elongated opening.

On the other hand, in the wheel train acceptor 206, the fourth gear portion 214, the base plate 204 and the second gear portion 224 which are positioned between the control board 271 and the cylindrical gear portion 234 of the cylindrical wheel 230, openings 206i, 206r, 214i, 214r, 204i, 204r, 224i, 224r are formed to open the incident optical path P2i between the light emitting part 280 and the reflection face R200 of the cylindrical wheel 230 and the reflection optical path P2r between the reflection face R200 and the light receiving part 290. Accordingly, when the second wheel 210, the minute wheel 220 and the hour wheel 230 are respectively at the initial positions Si201, Si202, Si203 shown in FIG. 9B and FIG. 10, the incident beam B2i which is emitted from the light emitting face 284 of the light emitting part 280 reaches the reflection face R200 through the incident-light passing opening portions 206i, 214i, 204i, 224i which constitute incident-optical-path-forming opening portions along the incident optical path P2i, and is reflected on the reflection face R200 as the reflection light B2r, and the reflection light B2r reaches the light receiving face 294 of the light receiving part 290 through the reflection-light-passing opening portions 224r, 204r, 214r, 206r which constitute the reflection-optical-path-forming opening portions along the reflection optical path P2r. Here, in the watch 102, to prevent a stray light from entering the light receiving part 290, the parts 206, 214, 204, 224 and the like typically have no openings at portions other than the incident-light-passing opening portions and the reflection-light-passing opening portions unless these parts become excessively heavy. However, at portions or regions where the possibility that the stray light enters the light receiving part is small, the openings or the like may be formed. Further, with respect to the watch 102, it is needless to say that the possibility of intrusion of an external light or the like can be suppressed to a minimum level due to an exterior case (not shown in the drawing) or the like.

Respective openings 206i, 206r, 214i, 214r, 204i, 204r, 224i, 224r are typically formed of a passing hole, that is, a through hole. However, if desired, these openings may be formed of a window made of a transparent (light transmitting) material Further, respective openings 206i, 206r, 214i, 214r, 204i, 204r, 224i, 224r are typically formed perpendicularly in respective plate-like portions for facilitating the manufacture thereof. However, if desired, for example, the respective openings may be inclined along the direction of the lights B2i, B2r which pass respective openings. Here, when the opening is comprised the through hole in the perpendicular direction, for example, as shown in FIG. 9 and the like, with respect to the wheel train acceptor 206 and the base plate 204 which have a relatively large thickness and a high mechanical strength and is placed in a stationary manner, the diameters of the openings 206i, 206r, 204i, 204r may be made large values, while with respect to the fourth gear 214, the second gear 224 and the like which is relatively thin and receives a force relevant to the rotation, the diameters of the openings 214i, 214r, 224i, 224r may be made small. Further, the incident-optical-path forming openings which form the incident optical path P2i and the reflection-optical-path forming openings which form the reflection optical path P2r may differ in sizes. Further, in place of making respective openings allow the peripheral portions of the incident beam B2i and the reflection beam B2r to pass therethrough, portions of the beam may be cut depending on the openings.

In the hand position detection device 101 having such a constitution, since the light emitting face 284 of the light emitting element 281 of the light emitting part 280 is arranged at the inside (the lower side as viewed in FIG. 9B) than the top portion 287 of the light shielding wall 285, even when a portion of light which is emitted from the light emitting face 284 of the light emitting part 280 spreads as in the case of the beam portion B2e1, the portion of the light impinges on the light shielding wall 285 and is blocked by the light shielding wall 285 and hence, the possibility that the beam portion B2e1 becomes a stray light and enters the light receiving face 294 of the light receiving part 290 is small. Further, in the hand position detection device 101, it is possible to position the top portions 287, 297 of the light shielding walls 285, 295 extremely close to the counter face 206n of the neighboring wheel train acceptor 206 with minute gaps G201, G202 defined between them and hence, there is small possibility that the peripheral portion B2e2 of the light emitted from the light emitting element 281 becomes a stray light and enters the light receiving face 294 of the light receiving part 290 through the gap G201.

Further, in the hand position detection device 101 having such a constitution, the light emitting element 281 and the light shielding wall 285 of the light emitting part 280 and the light receiving element 291 and the light shielding wall 295 of the light receiving part 290 are formed on the bottom face 274 of the recessed portion 273 of the control board 271, and the top portions 287, 297 of the light shielding walls 285, 295 are positioned extremely close to the counter face 206a of the neighboring wheel train acceptor 206 and hence, the main surface 272 of the control board 271 can be arranged close to the counter face 206n of the neighboring wheel train acceptor 206 whereby the distance D200 between the control board 271 of the circuit block 270 and the dial 207 can be reduced to a minimum level thus realizing the reduction of thickness of the watch 102.

Further, in the hand position detection device 101 having such a constitution, the light shielding walls 285, 295 also function as the sealing wall portions and hence, it is not necessary to provide the sealing wall portions in addition to the light shielding walls and, at the same time, it is unnecessary to provide the light shielding walls in addition to the sealing wall portions. Further, since the light shielding walls 285, 295 also function as the sealing wall portions, the light emitting element 281 and the lead wire 282 which constitute the light emitting part 280 and the light receiving element 291 and the lead wire 292 which constitute the light receiving part 290 can be easily sealed to be held in a stable manner and, at the same time, the sizes of the light emitting part 280 and the light receiving part 290 in the lateral direction can be set to a minimum value and hence, it is possible to arrange the light emitting part 280 and the light receiving part 290 to the optimum positions for receiving and emitting light.

Further, in the hand position detection device 101 having such a constitution, between the incident optical path P2i and the reflection optical path P2r, the wall portions 206w, 214w, 204w, 224w, (that is, the wall portions between respective openings 206i, 214i, 204i, 224i and 206r, 214r, 204r, 224r) of the related parts 206, 214, 204, 224 are positioned and hence, there is small possibility that a portion of the incident light B2i reaches the light receiving face 294 of the light receiving part 290 as a stray light passing through an optical path offset from the original incident optical path P2i and reflection optical path P2r whereby there is small possibility that an erroneous operation is generated at the time of detecting the positions.

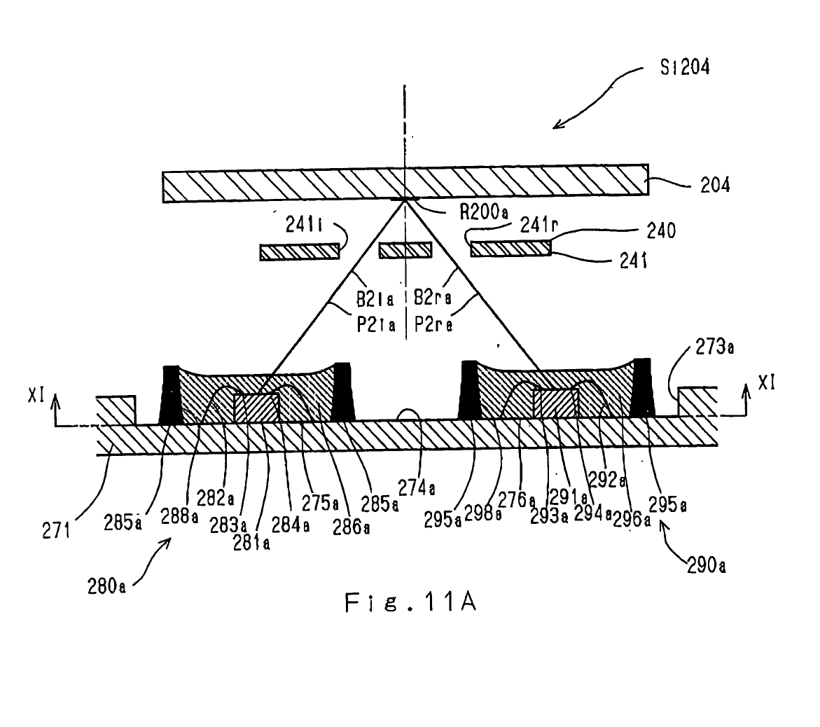

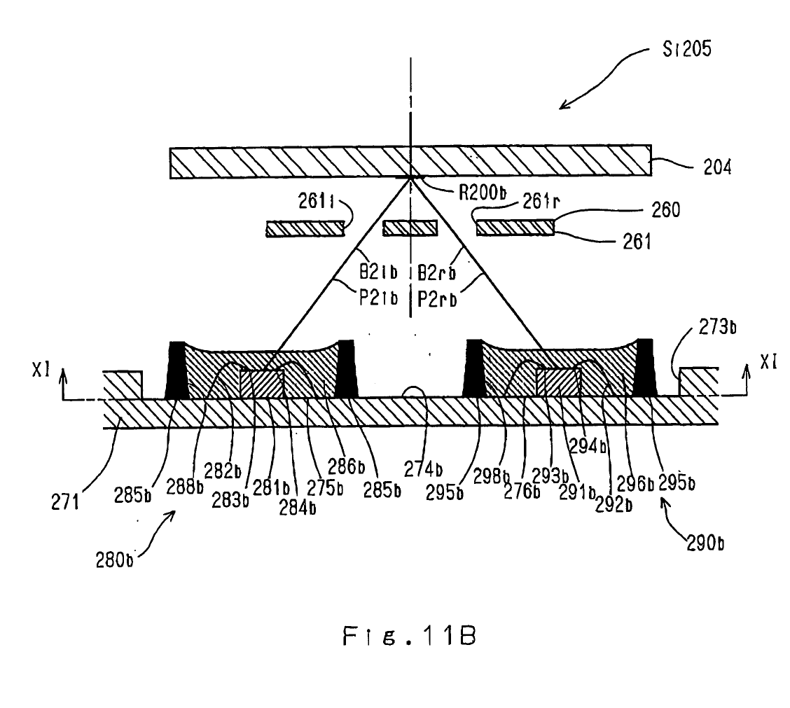

Here, this hand position detection device 101 of the watch 102 further includes, as shown in FIG. 10 and FIG. 11, a similar rotational position detection system which detects the rotational positions of the fifth wheel 240 and the third wheel 260.

That is, as shown in FIG. 10 and FIG. 1A, a recessed portion 273a is further formed in the control board 271 and a light emitting element 281a of a light emitting part 280a and a light receiving element 291a of a light receiving part 290a are inserted into the recessed portion 273a. The light emitting element 281a and the light receiving element 291a are electrically connected to wiring pattern regions 275a, 276a of the control board 271 through lead wires 282a, 292a. Around the light emitting element 281a and a wiring pattern region 275a thereof as well as around the light receiving element 291a and a wiring pattern region 276a thereof, light shielding walls 285a, 295a which also function as sealing frames are formed. In the regions inside the light shielding walls 285a, 295a, sealing resins 286a, 296a are filled so as to seal the related elements 281a, 291a and wires 282a, 292a in the inside of the resins 286a, 296a. Further, in a fifth gear 241 of a fifth wheel 240, an opening 241i for an incident optical path P2ia of an incident light B2ia from a light emitting face 284a of the light emitting part 280a and an opening 241r for a reflection optical path P2ra of a reflection light B2ra to a light receiving face 294a of the light receiving part 290a are formed. In this embodiment, a reflection face R200a is formed on the base plate 104.

In the same manner, as shown in FIG. 10 and FIG. 11B, a recessed portion 273b is further formed in the control board 271 and a light emitting element 281b of a light emitting part 280b and a light receiving element 291b of a light receiving part 290b are inserted in the recessed portion 273b. The light emitting element 281b and the light receiving element 291b are electrically connected to wiring pattern regions 275b, 276b of the control board 271 through lead wires 282b, 292b. Around the light emitting element 281b and a wiring pattern region 275b thereof as well as around the light receiving element 291b and a wiring pattern region 276b thereof, light shielding walls 285b, 295b which also function as sealing frames are formed. In the regions inside the light shielding walls 285b, 295b, sealing resins 286b, 296b are filled so as to seal the related elements 281b, 291b and wires 282b, 292b in the inside of the resins 286b, 296b. Further, in a third gear 261 of a third wheel 260, an opening 261i for an incident optical path P2ib of an incident light B2ib from a light emitting face 284b of the light emitting part 280b and an opening 261r for a reflection optical path P2rb of a reflection light B2rb to a light receiving face 294b of the light receiving part 290b are formed. In this embodiment, a reflection face R200a is, for example, formed on the base plate 204 or an intermediate frame which is placed in a stationary manner with respect to the base plate 204.

Accordingly, in the hand position detection device 101, the positioning of the fifth wheel 240 and the third wheel 260 at the initial positions Si204 and Si205 can be detected by the detection systems 280a, R200a, 290a as well as 280b, R200b, 290b. As a result, in the hand position detection device 101, in the same manner as the previous embodiments, it is possible to detect the rotational positions of the fifth wheel 240 and the third wheel 260 without substantially increasing a thickness of a watch 102 and, at the same time, by suppressing the possibility that the light receiving parts 280a, 280b erroneously detect a stray light to a minimum level. By simultaneously detecting the rotational positions of the fifth wheel 240 and the third wheel 260, it is possible to enhance the angular resolution with respect to the detection of positions of the second hand 213 and the minute hand 223.

In the above-mentioned constitution, the rotational positions of the respective wheels 210, 220, 230, 240, 260 are detected. However, provided that the rotational position or the hand position of at least one wheel can be detected, it is sufficient for the hand position detection device that the hand position detection device can detect the rotational position of any one of these wheels. The reflection faces R, R200a, R200b may be either stationary or movable with respect to a casing (not shown in the drawing) of the device 101. When the reflection face is stationary, the light emitting part and the light receiving part may be moved integrally.

Further, in the above-mentioned embodiments, the explanation is made with respect to the case in which the incident optical path P2i and the reflection optical path P2r are respectively provided one for each detection system consisting of the light emitting element, the light receiving element and the reflection face and the optical-path-forming openings are formed one for each part to be detected 214, 224 or the like. However, if desired, a plurality of incident-optical-path forming openings or a plurality of reflection-optical-path forming openings may be formed such that two or more incident optical paths P2i or two or more reflection optical paths P2r are formed for one light emitting part or one light receiving part. Further, a plurality of incident-optical-path forming openings or a plurality of reflection-optical-path forming openings may be formed for one gear or each gear.

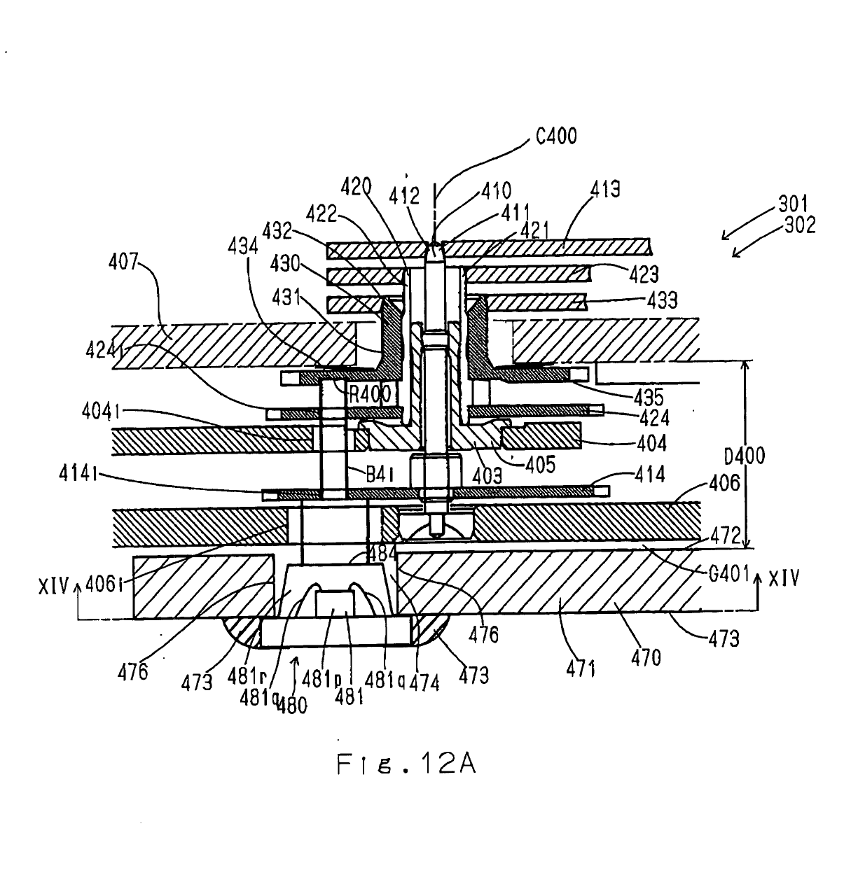

Further, in FIG. 12 to FIG. 14, the watch 302 includes a second hand 410, a minute wheel 420 and an hour wheel 430 concentrically about rotational center axis. As shown in FIG. 12A, a second hand 413 is mounted on a distal end 412 of the rotational center axis 411 of the second wheel 410 and a minute hand 423 is mounted on a distal end 422 of the rotational center axis 421 of the minute wheel 420.

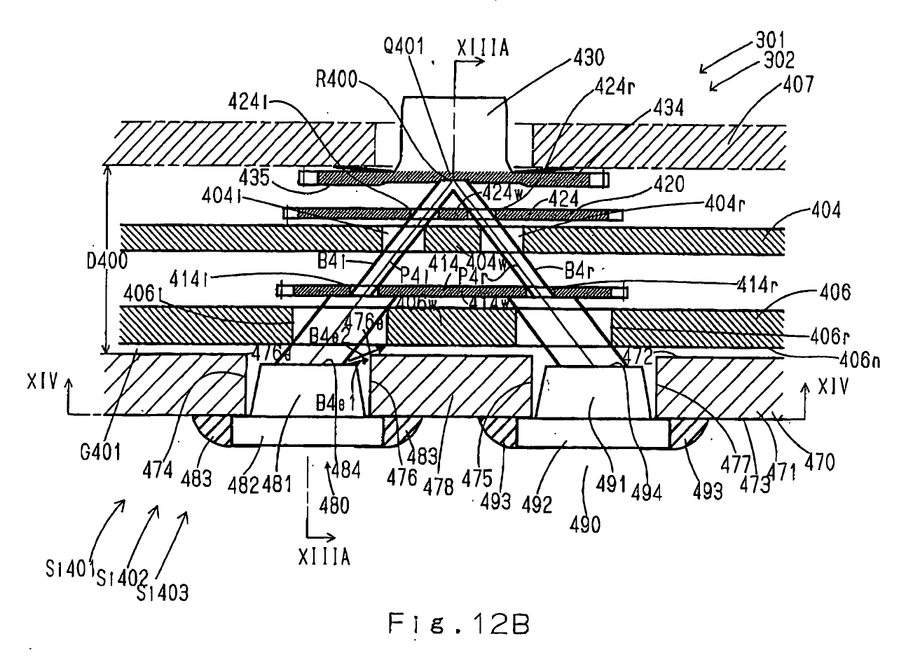

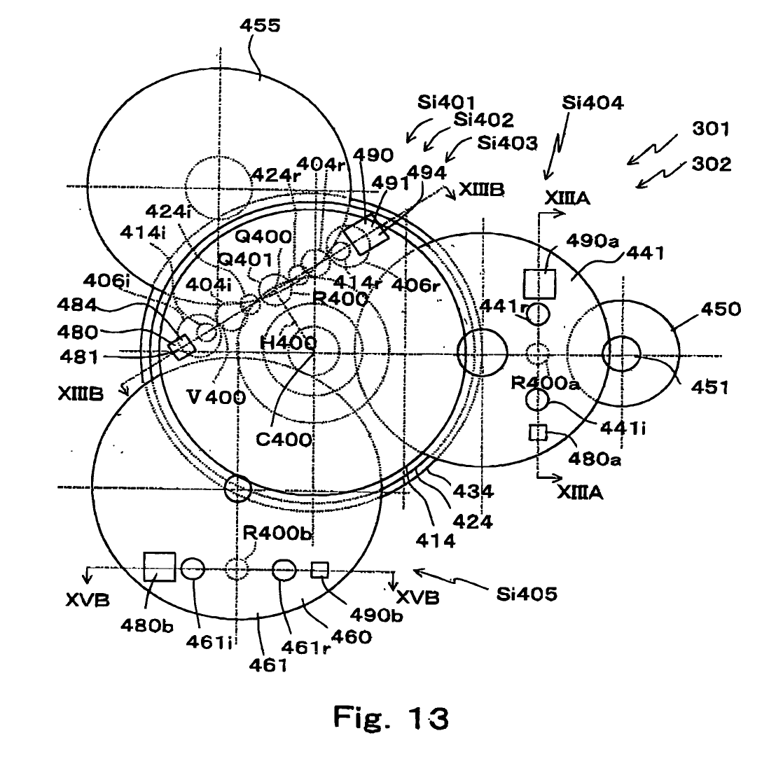

A gear of the second wheel 410 or a fourth gear 414 is coupled to a rotor 451 of a motor 450 by way of a wheel (gear) such as a fifth gear 440 or a wheel train (a gear train) (see FIG. 13) and a gear of the minute wheel 420 or a second gear 424 is coupled to the minute wheel 420 by way of a third gear 460 (see FIG. 13).

A guide pipe 405 which has a flange-like portion 403 thereof supported on a base plate 403 is arranged between a rotational center axis 411 of the second wheel 410 and a cylindrical rotational center axis 421 of the minute wheel 420, wherein both wheels are rotatably supported and the wheel train acceptor 406 pivotally supports the second wheel 410. Numeral 407 indicates a dial.

A control board 471 which constitutes a printed circuit board of a circuit block 470 is arranged close to the wheel train acceptor 406 such that one main surface 472 thereof faces a main surface 406n of the wheel train acceptor 406 by way of a small gap G401. The control board 471 includes a pair of openings or windows 474, 475 in a form of through holes which penetrate from one main surface 472 to the other main surface 473 of the board 471. In the control board 471, a light emitting part 480 is formed in the opening 474 and a light receiving part 490 is formed in the opening 475. Here, a thickness of the control board 471 is, for example, approximately 0.2-0.5 mm, a size (diameter in case of a circular shape, size of one side in case of a rectangular shape) of the opening is 0.5-1 mm, and an interval of openings is 2-3 mm. However, any of these sizes may be made larger or smaller.

In this embodiment, the openings 474, 475 are illustrated in the drawings such that the openings 474, 475 appear to have a fixed cross-sectional shape as viewed in the thickness direction of the board 471. However, if desired, it is sufficient that the openings 474, 475 may differ in at least a portion of the cross-sectional shape in the thickness direction. For example, the openings 474, 475 may be increased in size from the main surface 472 to the main surface 473. Alternatively, the openings 474, 475 may be increased in size from the main surface 473 to the main surface 472. Further, the shape per se of the openings 474, 475 may be changed along the thickness direction.

To be more specific, the light emitting part 480 includes a light emitting element 481 such as an LED and a light emitting element supporting board or a light emitting element mounting board 482 on which the light emitting element 481 is mounted. The light emitting part 480 is mounted on the control board 471 such that, to accommodate the light emitting element 481 in the inside of the opening 474, the light emitting element 481 is inserted from a back-face-473-side of the control board 471 such that an element-481-side surface of the mounting board 482 is brought into contact with a back face 473 of the control board 471, and the light emitting element 481 is bonded to a wiring pattern on the back face 473 of the control board 471 by way of a bonding portion 483 such as a soldering portion on the mounting board 482. In a state that the light emitting part 480 is mounted on the control board 471, a light emitting face 484 of the light emitting element 481 of the light emitting part 480 is retracted from the main surface 472 of the control board 471 so that the light emitting face 484 is surrounded by a peripheral wall 476 of the opening 474. Accordingly, the peripheral wall 476 of the opening 474 per se functions as a light shielding wall portion. Here, the light emitting element 481 is typically comprised, as shown in FIG. 12A, an LED chip 481p, a bonding wire 481q which connects a terminal of the LED chip 481p and a terminal of the mounting board 482, and a transparent sealing resin 481r which seals the chip 481p and the wire 481q.

In the same manner, the light receiving part 490 includes a light receiving element 491 such as a photo transistor and a light receiving element supporting board or a light receiving element mounting board 492 on which the light receiving element 491 is mounted. The light receiving part 490 is mounted on the control board 471 such that, to accommodate the light receiving element 491 in the inside of the opening 475, the light receiving element 491 is inserted from a back-face-473-side of the control board 471 such that an element-491-side surface of the mounting board 492 is brought into contact with a back face 473 of the control board 471, and the light receiving element 491 is bonded to a wiring pattern on the back face 473 of the control board 471 by way of a bonding portion 493 such as a soldering portion on the mounting board 492. In a state that the light receiving part 490 is mounted on the control board 471, a light receiving face 494 of the light receiving element 491 of the light receiving part 490 is retracted from the main surface 472 of the control board 471 so that the light receiving face 494 is surrounded by a peripheral wall 477 of the opening 475. Accordingly, the peripheral wall 477 of the opening 475 per se functions as a light shielding wall portion. Further, a wall portion 478 which separates the openings 474, 475 functions as a partitions wall between the light emitting part 480 and the light receiving part 490. Here, although not shown in the drawings, the light receiving element 491 is also typically comprised, as in the case of the light emitting element 481, a light receiving chip such as a photo transistor, a bonding wire which connects a terminal of the chip and a terminal of the mounting board 492, and a transparent sealing resin which seals the light receiving chip and the wire.

An interval or a distance between the light-emitting-element inserting opening 474 and the light-receiving-element inserting opening 475, that is, a length of a partition wall 478 is set to a length which can obviate the possibility that a stray light of the light emitted from the light emitting element 481 is erroneously received by the light receiving element 491 by taking the size of a gap G401 between the main surface 472 of the control board 471 and a counter face 406n of the wheel train acceptor 406 into consideration.

Here, in the embodiment shown in FIG. 12, the light emitting face 484 of the light emitting element 481 and the light receiving face 494 of the light receiving element 491 are set parallel to the main surface 472 of the control board 471. However, if desired, to enhance the light reception efficiency of the light, the light emitting element 481 and the light receiving element 491 may be respectively arranged in the inside of the opening 474, 475 such that that the light emitting face 484 is directed in the direction substantially orthogonal to the incident optical path P4i of the incident light B4i emitted from the light emitting element 481 or the light receiving face 494 is directed in the direction substantially orthogonal to a reflection optical path P4r of the reflection light B4r. Further, a turn round optical system which directs the light from the light emitting face 484 of the light emitting element 481 to the incident optical path P4i or a shaping optical system which approximates the beam B4i to the parallel beam B4i may be provided. The same goes for the light receiving element 491.

As can be understood from FIG. 12A and FIG. 13 which shows a cross section taken along a line XIIIA-XIIIA in FIG. 12B, the light emitting part 480 and the light receiving part 490 are arranged in the direction where an imaginary line V400 which connects the light emitting element 481 and the light receiving element 491 is directed in the direction orthogonal to the radial direction H400 of the rotational center axis C400 of the watch 302, that is, the rotational center axis C400 of the second wheel 410, the minute wheel 420 and the hour wheel 430 (the direction orthogonal to the radial direction line H400 which connects an intermediate point Q400 of the imaginary line V400 and the center C400 ). Due to such a constitution, it is possible to arrange the light emitting element 481 and the light receiving element 491 in a spaced-apart manner while obviating the small gears, the pinion portions or the like of the second wheel 410, the minute wheel 420 and the hour wheel 430. Here, if desired, in place of arranging the imaginary line V400 and the radial direction line H400 orthogonal to each other (90 degrees), the imaginary line V400 and the radial direction line H400 may cross each other obliquely. However, an angle made by the imaginary line V400 and the radial direction line H400 may preferably be at least approximately 30 degrees or more, more preferably approximately 45 degrees or more, and still more preferably approximately 60 degrees or more.

A cylindrical gear portion 434 of a cylindrical wheel 430 has a reflection face R400 at a position where the light from the light emitting face 484 of the light emitting element 481 of the light emitting part 480 is obliquely incident through the incident optical path P4i as the incident beam or the incident light B4i in a state that the hour hand 433 is at the initial position Si403, the incident light B4i is obliquely reflected and the reflected light B4r reaches the light receiving face 494 of the light receiving element 491 of the light receiving part 490 through the reflection optical path P4r. To be more specific, the reflection face R400 is formed at a position Q401 where a position Q400 of a perpendicular Q400 which is drawn downwardly from the rotational center C400 is overlapped to the imaginary line V400 which connects the light emitting part 480 and the light receiving part 490 when the cylindrical gear portion 434 is at the initial position Si403 as viewed in a plan view (a planner cross-sectional view) as shown in FIG. 13 with respect to the surface 435 of the cylindrical gear portion 434 at a side which faces the control board 471. Here, if desired, openings for allowing passing of the incident and reflection light beams B4i, B4r are also formed in the cylindrical gear portion 434 and the reflection face R400 may be formed on the dial 407. In this case, the openings formed in the cylindrical gear portion 434 for allowing passing of the incident and reflection light beams B4i, B4r may be formed of a single elongated opening.

On the other hand, in the wheel train acceptor 406, the fourth gear portion 414, the base plate 404 and the second gear portion 424 which are positioned between the control board 471 and the cylindrical gear portion 434 of the cylindrical wheel 430, openings 406i, 406r, 414i, 414r, 404i, 404r, 424i, 424r are formed to open the incident optical path P4i between the light emitting part 480 and the reflection face R400 of the cylindrical wheel 430 and the reflection optical path P4r between the reflection face R400 and the light receiving part 490. Accordingly, when the second wheel 410, the minute wheel 420 and the hour wheel 430 are respectively at the initial positions Si401, Si402, Si403 shown in FIG. 12B and FIG. 13, the incident light B4i which is emitted from the light emitting face 484 of the light emitting part 480 reaches the reflection face R400 through the incident-light passing opening portions 406i, 414i, 404i, 424i which constitute incident-optical-path-forming opening portions along the incident optical path P4i, and is reflected on the reflection face R400 as the reflection light B4r, and the reflection light B4r reaches the light receiving face 494 of the light receiving part 490 through the reflection-light-passing opening portions 424r, 404r, 414r, 406r which constitute the reflection-optical-path-forming opening portions along the reflection optical path P4r. Here, in the watch 302, to prevent a stray light from entering the light receiving part 490, the parts 406, 414, 404, 424 and the like typically have no openings at portions other than the incident-light-passing opening portions and the reflection-light-passing opening portions unless these parts become excessively heavy. However, at portions or regions where the possibility that the stray light enters the light receiving part is small, the openings or the like may be formed. Further, with respect to the watch 302, it is needless to say that the possibility of intrusion of an external light or the like can be suppressed to a minimum level due to an exterior casing (not shown in the drawing) or the like.

Respective openings 406i, 406r, 414i, 414r, 404i, 404r, 424i, 424r are typically formed of a passing hole, that is, a through hole. However, if desired, these openings may be formed of a window made of a transparent (light transmitting) material. Further, respective openings 406i, 406r, 414i, 414r, 404i, 404r, 424i, 424r are typically formed perpendicularly in respective plate-like portions for facilitating the manufacture thereof. However, if desired, for example, the respective openings may be inclined along the direction of th lights which pass through respective openings. Here, when the opening is comprised the through hole in the perpendicular direction, for example, as shown in FIG. 12 and the like, with respect to the wheel train acceptor 406 and the base plate 404 which has a relatively large thickness and a high mechanical strength and is placed in a stationary manner, the diameters of the openings 406i, 406r, 404i, 404r may be increased, while with respect to the fourth gear 414, the second gear 424 and the like which is relatively thin and receives a force relevant to the rotation, the diameters of the openings 414i, 414r, 424i, 424r may be decreased. Further, the incident-optical-path forming openings which form the incident optical path P4i and the reflection-optical-path forming openings which form the reflection optical path P4r may differ in size. Further, in place of making the peripheral portions of the incident beam B4i and the reflection beam B4r transmissive by respective openings, portions of the beam may be cut depending on openings.

In the hand position detection device 301 having such a constitution, since the light emitting face 484 of the light emitting element 481 of the light emitting part 480 is arranged at the inside (the lower side as viewed in FIG. 12B) than the end periphery 476e of the peripheral wall 476 of the opening portion 474, even when a portion of light which is emitted from the light emitting face 484 of the light emitting part 480 spreads as in the case of the beam portion 4Be1, the portion of the light impinges on the peripheral wall 476 and is blocked by the peripheral wall 476 and hence, the possibility that the beam portion B4e1 becomes a stray light and enters the light receiving face 494 of the light receiving part 490 is small, Further, in the hand position detection device 301, since the light emitting face 484 of the light emitting element 481 of the light emitting part 480 is arranged at the inside of the end periphery 476e of the peripheral wall 476 of the opening portion 474, it is possible to arrange the main surface 472 of the opening portion 476 having the end periphery 476e extremely close to the counter face 406n of the neighboring wheel train acceptor 406 to make the size (width) of the gap G401 very small whereby there is small possibility that the peripheral portion B4e2 of the light emitted through the opening 474 becomes a stray light and enters the light receiving face 494 of the light receiving part 490 through the gap G401.

Further, in the hand position detection device 301, the light emitting face 484 of the light emitting element 481 of the light emitting part 480 is arranged at the inside than the end periphery 476e of the peripheral wall 476 of the opening portion 474 and hence, it is possible to arrange the main surface 472 of the opening portion 476 having the end periphery 476e extremely close to the counter face 406n of the neighboring wheel train acceptor 406 whereby the size (width) of the gap G401 can be made extremely small. Accordingly, the distance D400 between the control board 471 of the circuit block 470 and the dial 407 can be reduced to a minimum level thus realizing the reduction of thickness of the watch 301. Here, the mounting boards 482, 492 which are positioned at the back face 474 side of the control board 471 require only a thickness necessary for connection terminals thereof and hence, the thickness of the mounting boards 482, 492 can be sufficiently made thin compared to the thickness of various circuit parts to belmounted on the control board 471 whereby the possibility that the presence of the mounting boards 482, 492 obstructs the reduction of the thickness of the watch 301 is small.

Here, although the easiness of mounting may be lowered in some cases, if desired, a portion or the whole mounting boards 482, 492 in the thickness direction may be formed into sizes or shapes which allow the entrance of the mounting boards 482, 492 into respective openings 474, 475. However, even in such a case, the mounting boards 482, 492 are bonded to the back face 473 side of the control board 471 using soldering layers 483, 493 or the like.

In this case, as a matter of course, as the light emitting element 481 and the light receiving element 491, those elements which have small thicknesses compared to the control board 471 are used such that the light emitting face 484 and the light receiving face 494 are positioned at the inside (the lower side in FIG. 12) than the main surface 472 of the control board 471. Further, depending op cases, with respect to the light emitting part 480, for example, the LED chip per se is formed into a shape which conforms to the whole shape of the element and the mounting board indicated by symbols 481 and 482 in FIGS. 12 A, B and the chip may be directly mounted on the back face 473 side of the control board 471 using a bonding means 483. The same goes for the light receiving part 490.

Here, in the,hand position detection device 301 by merely mounting the light emitting part 480 and the light receiving part 490 in the openings 474, 475 which are preliminarily formed in the control board 471, positioning of the light emitting part 480 and the light receiving part 490 can be performed and hence, positioning of the related parts of the hand position detection device 301 can be easily performed with high reliability and high accuracy.

Further, in the hand position detection device 301, between the incident optical path P4i and the reflection optical path P4r, the wall portions 406w, 414w, 404w, 424w, (that is, wall portions between the respective openings 406i, 414i, 404i, 424i and the respective openings 406r, 414r, 404r, 424r) of the related parts 406, 414, 404, 424 are positioned and hence, there is small possibility that a portion of the incident light B4i reaches the light receiving face 494 of the light receiving part 490 as a stray light passing through an optical path offset from the original incident optical path P4i and reflection optical path P4r whereby there is small possibility that an erroneous operation is generated at the time of detecting the positions.

Here, the shapes (the cross-sectional shapes) of the openings 474, 475 in which the light emitting element 481 and the light receiving element 491 are to be inserted may be substantially equal to (typically similar to) or different from the cross-sectional shapes of the corresponding light emitting element 481 and light receiving element 491. Further, provided that the incident optical path P4i and the reflection optical path P4r in the oblique direction can be formed, it is preferable that the light emitting face 484 and the light receiving face 494 of the light emitting element 481 and the light receiving element 491 may be arranged at positions deeper than the main surface 472 of the control board 471 (lower side in FIGS. 12A, B). However, when the provision simply increases the thickness of the control board 471 and hence increases the thickness of the watch 302, the increase of the thickness of the control board 471 may be suitably determined in response to the size requested by a final product such as the watch 302 or the like.

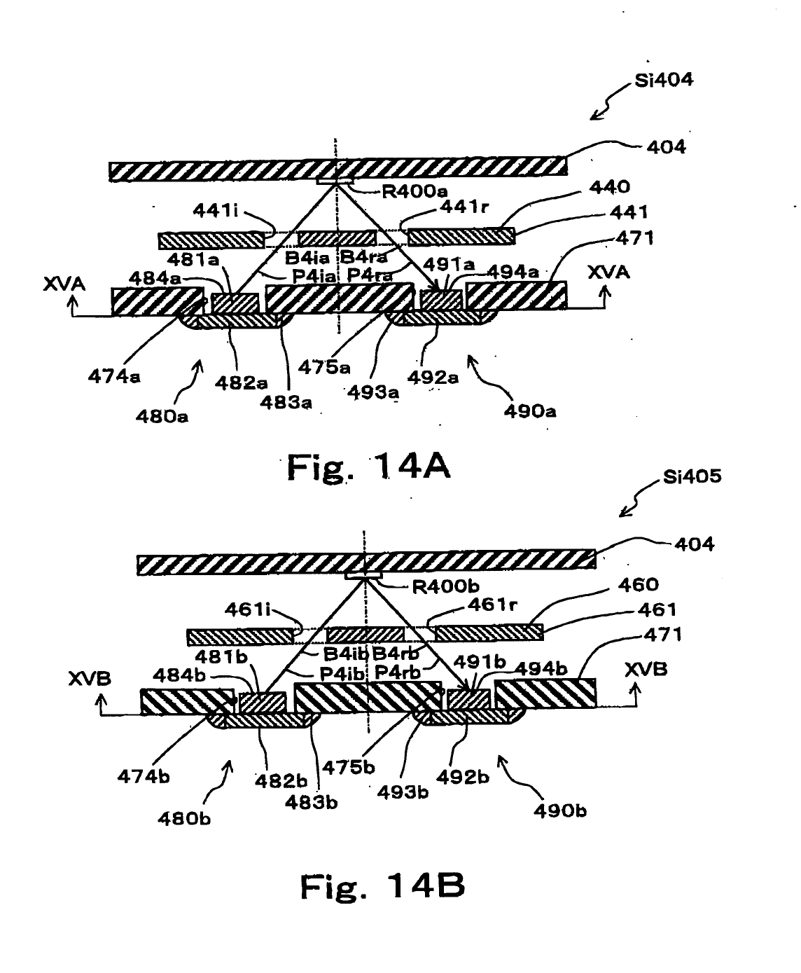

Here, this hand position detection device 301 of the watch 302 further includes, as shown in FIG. 13 and FIG. 14, a rotational position detection system which detects the rotational positions of the fifth wheel 440 and the third wheel 460.

That is, as shown in FIG. 13 and FIG. 14A, openings 474a, 475a are formed in the control board 471 and a light emitting element 481a of a light emitting part 480a and a light receiving element 491a of a light receiving part 490a are inserted into the openings 474a and 475a. The light emitting element 481a and the light receiving element 491a are bonded to the back face 473 of the control board 471 by way of the mounting boards 482a, 492a and bonding portions 483a, 493a. Further, in a fifth gear 441 of a fifth wheel 440, an opening 441i for an incident optical path P4ia of an incident light B4ia from a light emitting face 484a of the light emitting part 480a and an opening 441r for a reflection optical path P4ra of a reflection light B4ra to a light receiving face 494a of the light receiving part 490a are formed. In this embodiment, a reflection face R400a is formed on the base plate 404.

In the same manner, as shown in FIG. 13 and FIG. 14B, openings 474b, 475b are formed in the control board 471 and a light emitting element 481b of a light emitting part 480b and a light receiving element 491b of a light receiving part 490b are inserted into the openings 474b and 475b. The light emitting element 481b and the light receiving element 491b are bonded to the back face 473 of the control board 471 by way of the mounting boards 482b, 492b and bonding portions 483b, 493b. Further, in a third gear 461 of a third wheel 460, an opening 461i for an incident optical path P4ib of an incident light B4ib from a light emitting face 484b of the light emitting part 480b and an opening 461r for a reflection optical path P4rb of a reflection light B4rb to a light receiving face 494b of the light receiving part 490b are formed. In this embodiment, the reflection face R400a is formed on the base plate 404, or an intermediate frame which is placed in a stationary manner with respect to the base plate 404 or the like, for example.

Accordingly, in the hand position detection device 301, the positioning of the fifth wheel 440 and the third wheel 460 at the initial positions Si404 and Si405 can be detected by the detection systems 480a, R400a, 490a as well as by the detection systems 480b, R400b, 490b. As a result, in the hand position detection device 301, in the same manner as the above-mentioned embodiments, it is possible to detect the rotational positions of the fifth wheel 440 and the third wheel 460 without substantially increasing a thickness of the watch 301 and, at the same time, by suppressing the possibility that the light receiving parts 480a, 480b erroneously detect a stray light to a minimum level. By simultaneously detecting the rotational positions of the fifth wheel 440 and the third wheel 460, it is possible to enhance the angular resolution with respect to the detection of positions of the second hand 413 and the minute hand 423.

In the above-mentioned constitution, the rotational positions of the respective wheels 410, 420, 430, 440, 460 are detected. However, provided that the rotational position or the hand position of at least one wheel can be detected, it is sufficient for the hand position detection device if the rotational position of any one of these wheels can be detected. The reflection faces R400, R400a, R400b may be either stationary or movable with respect to a casing (not shown in the drawing) of the device 301. When the reflection face is stationary, the light emitting part and the light receiving part may be moved integrally.

In the above-mentioned embodiments, the explanation is made with respect to the case in which the incident optical path P4i and the reflection optical path P4r are respectively provided one for each detection system consisting of the light emitting element, the light receiving element and the reflection face and the optical-path-forming openings are formed one for each part to be detected 414, 424 or the like. However, if desired, a plurality of incident-optical-path forming openings or a plurality of reflection-optical-path forming openings may be formed such that two or more incident optical paths P4i or two or more reflection optical paths P4r are formed for one light emitting part or one light receiving part. Further, a plurality of incident-optical-path forming openings or a plurality of reflection-optical-path forming openings may be formed for one gear or each gear.

Further, in the above-mentioned constitutions, the control board means a board having a wiring pattern on which the light emitting element and the light receiving element are mounted and may separately include a control board which is originally for the watch and other printed circuit board provided that they can contribute to the reduction of thickness of the watch eventually in view of some purposes.

Further, the explanation is made with respect to the case in which the wheels are directly or indirectly connected to one motor with respect to the rotation thereof and hence, only the fact that the hour wheel, the minute wheel and the second wheel reaches the initial positions, that is, the agreement of the rotational positions of the hour wheel, the minute wheel and the second wheel is only detected. However, in case of a rotational system in which the hour wheel, the minute wheel and the second wheel can be rotated independently using two or more motors, it may be further possible to detect suitably or sequentially the fact that some wheels out of the hour wheel, the minute wheel and the second wheel reach the initial positions or the fact that at least some wheels out of the hour wheel, the minute wheel and the second wheel arrive at positions close to the initial positions.

What is claimed is:

1. A rotational position detection device comprising:
a first light emitting part which is mounted on a first support body;
a first reflection face which is formed on a second support body which is arranged to face the first support body with a gap therebetween such that light from the first light emitting part is obliquely incident on the first reflection face;
a first light receiving part mounted on the first support body at a position away from the first light emitting part to receive light obliquely reflected on the first reflection face; and
a first disc-like rotary body which is arranged in the gap between the first and the second support bodies, the first disc-like rotary body having a first opening means which opens a first incident optical path leading from the first light emitting part to the first reflection face and a first reflection optical path leading from the first reflection face to the first light receiving part when the first disc-like rotary body assumes a first rotational position with respect to the first support body, wherein
when the first disc-like rotary body assumes the first rotational position, a first imaginary line which connects a first incident optical path part in which the first incident optical path passes through and a first reflection optical path part in which the first reflection optical path passes through in the first opening means extends in the direction which intersects the radial direction of the first disc-like rotary body.

2. A rotational position detection device according to claim 1, wherein a radial directional line which connects an intermediate point of the first imaginary line and the center of the first disc-like rotary body is set orthogonal to the first imaginary line.

3. A rotational position detection device according to claim 1, wherein the first opening means is comprised a first elongated opening which continuously extends between the first incident optical path part and the first reflection optical path part.

4. A rotational position detection device according to claim 1, wherein the first opening means includes a first incident optical path forming small opening portion which allows passing of incident light from the first light emitting part to the first reflection face and a first reflection optical path forming small opening portion which is arranged spaced apart from the first incident optical path forming small opening portion and allows passing of reflection light from the first reflection face to the first light receiving part.

5. A rotational position detection device according to claim 1, wherein the first light emitting part and the first light receiving part are mounted on a light emitting part mounting region and a light receiving part mounting region of one main surface which faces the first reflection face out of the first support body, and a light shielding part which blocks advancing of a stray light from the light emitting part to the light receiving part is formed such that the light shielding part projects from one mounting region than at least either one of the light emitting part and the light receiving part.

6. A rotational position detection device according to claim 1, wherein the rotational position detection device further includes a second disc-like rotary body which is arranged parallel to the first disc-like rotary body in the gap between the first and the second support bodies, the second disc-like rotary body including a second opening means which opens a first incident optical path leading from the first light emitting part to the first reflection face and the first reflection optical path leading from the first reflection face to the first light receiving part when the second disc-like rotary body assumes a second rotational position with respect to the first support body, and
a second imaginary line which connects a second incident optical path part in which the first incident optical path passes through and a second reflection optical path part in which the first reflection optical path passes through out of the second opening means extends in the direction which intersects the radial direction of the second disc-like rotary body and is parallel to the first imaginary line when the first and the second disc-like rotary bodies respectively assume the first and the second rotational positions.

7. A rotational position detection device according to claim 6, wherein a radial directional line which connects an intermediate point of the second imaginary line and the center of the second disc-like rotary body is set orthogonal to the second imaginary line.

8. A rotational position detection device according to claim 6, wherein the second opening means is comprised a second elongated opening which continuously extends between the second incident optical path part and the second reflection optical path part.

9. A rotational position detection device according to claim 6, wherein the second opening means includes a second incident optical path forming small opening portion which allows passing of incident light from the first light emitting part to the first reflection face and a second reflection optical path forming small opening portion which is arranged spaced apart from the second incident optical path forming small opening portion and allows passing of reflection light from the first reflection face to the first light receiving part.

10. A rotational position detection device according to claim 6, wherein a rotational center axis of the second disc-like rotary body extends in parallel to a rotational center axis of the first disc-like rotary body with a distance defined therebetween.

11. A rotational position detection device according to claim 10, wherein the first and the second imaginary lines extend in the orthogonal direction with respect to the direction which connects the rotational center axes of the first and the second disc-like rotary bodies.

12. A rotational position detection device according to claim 6, wherein the second disc-like rotary body is arranged concentrically with the first disc-like rotary body.

13. A rotational position detection device according to claim 12, wherein the rotational position detection device further includes a third disc-like rotary body which is rotated about a rotational center axis which extends parallel to the rotational center axes of the first and the second disc-like rotary bodies in a spaced apart manner from the rotational center axes of the first and the second disc-like rotary bodies, the third disc-like rotary body including a third opening means which opens a first incident optical path leading from the first light emitting part to the first reflection face and the first reflection optical path leading from the first reflection face to the first light receiving part when the third disc-like rotary body assumes a third rotational position with respect to the first support body, and
a third imaginary line which connects a third incident optical path part in which the first incident optical path passes through and a third reflection optical path part in which the first reflection optical path passes through out of the third opening means extends in the direction which intersects the radial direction of the third disc-like rotary body and is parallel to the first and second imaginary lines when the first, the second and the third disc-like rotary bodies respectively assume the first, the second and the third rotational positions.

14. A rotational position detection device according to claim 1, wherein the rotational position detection device further includes:
a second light emitting part which is mounted on the first support body;
a second reflection face which is formed on a third support body which faces the first support body with a gap therebetween such that light from the second light emitting part is obliquely incident on the second reflection face;
a second light receiving part which is mounted at a position spaced apart from the second light emitting part in the first support body to receive light reflected obliquely on the second reflection face; and
a fourth disc-like rotary body which is arranged in the gap between the first and third support bodies, the fourth disc-like rotary body having a fourth opening means which opens the second incident optical path leading from the second light emitting part to the second reflection face and a second reflection optical path leading from the second reflection face to the second light receiving part when the fourth disc-like rotary body assumes a fourth rotational position with respect to the first support body, wherein a fourth imaginary line which connects a fourth incident light optical path part in which the second incident optical path passes through and a fourth reflection optical path part in which the second reflection optical path passes through out of the fourth opening means extends in the direction which intersects the radial direction of the fourth disc-like rotary body when the fourth disc-like rotary body assumes the fourth rotational position.

15. A rotational position detection device according to claim 14, wherein a radial directional line which connects an intermediate point of the fourth imaginary line and the center of the fourth disc-like rotary body is set orthogonal to the fourth imaginary line.

16. A rotational position detection device according to claim 14, wherein the fourth opening means is comprised a fourth elongated opening which continuously extends between the fourth incident optical path part and the fourth reflection optical path part.

17. A rotational position detection device according to claim 14, wherein the fourth opening means includes a fourth incident optical path forming small opening portion which allows passing of incident light from the second light emitting part to the second reflection face and a fourth reflection optical path forming small opening portion which is arranged spaced apart from the fourth incident optical path forming small opening portion and allows passing of reflection light from the second reflection face to the second light receiving part.

18. A rotational position detection device according to claim 1, wherein the second support body is placed in a stationary state with respect to the first support body.

19. A rotational position detection device according to claim 1, wherein the second support body is comprised a fifth disc-like rotary body which is concentric with the first disc-like rotary body.

20. A rotational position detection device according to claim 19, wherein a main surface of the fifth disc-like rotary body at a first-reflection-face-side includes a recessed portion in a small region having the reflection face and the reflection face is formed in a bottom face of the recessed portion.

21. A rotational position detection device according to claim 1, the disc-like rotary body is formed of a disc-like gear part.

22. A hand position detection device according to claim 21, wherein the first disc-like rotary body and a disc-like rotary body which is concentric with the first disc-like rotary body are provided with time display hands at one ends of rotary axis of the rotary bodies.

23. A watch provided with the hand position detection device according to claim 22.
